(19) United States
(12) Patent Application Publication
(10) Pub. No.: US 2003/0206681 A1
(43) Pub. Date: Nov. 6, 2003

(54) Integrating element for optical fiber communication systems based on photonic multi-bandgap quasi-crystals having optimized transfer functions

(75) Inventors: Leonid Polonskiy, Westwood, NJ (US); Vladimir Yankov, Washington Twp., NJ (US); Michael Spector, Hackensack, NJ (US); Andrei Talapov, Tenafly, NJ (US); Sergey Babin, Castro Valley, CA (US); Alexander Goltsov, Paramus, NJ (US); Anatoli Morozov, Hightstown, NJ (US); Natalya Polonskaya, Westwood, NJ (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Vyoptics, Inc., Allendale, NJ

(21) Appl. No.: 10/167,773

(22) Filed: Jun. 11, 2002

Related U.S. Application Data
(63) Continuation-in-part of application No. 10/137,150, filed on May 2, 2002, now Pat. No. 6,574,114.

(51) Int. Cl. G02B 6/26; G02B 6/293

(52) U.S. Cl. 385/15; 385/27; 385/39; 385/24

(57) ABSTRACT

The present invention provides a photonic multi-bandgap structure, herein also referred to as photonic bandgap quasi-crystal (“PBQC”), that can direct light, having wavelength components within a selected passband (Δλ), from an input port, to a predefined output port, while providing an integrating element for Planar Lightwave Circuits. A photonic bandgap quasi-crystal of the invention combines in a planar waveguide spectrally selective properties of gratings, focusing properties of elliptical mirrors, superposition properties of thick holograms, photonic bandgaps of periodic structures, and flexibility of binary lithography. A photonic structure of the invention can be utilized, for example, as an integrating spectrally sensitive element in a variety of optical devices that can include, but are not limited to, optical switches, optical multiplexer/demultiplexers, multi-wavelength lasers, and channel monitors in Wavelength Division Mulitplexing (WDM) telecommunications system.

### RELATED APPLICATIONS

The present application is a continuation-in-part (CIP) of U.S. patent application entitled “Photonic multi-bandgap lightwave device and methods for manufacturing thereof,” having a Ser. No. 10/137,150 and filed on May 2, 2002, herein incorporated by reference in its entirety.

### FIELD OF THE INVENTION

The present invention generally relates to optical communications and optical transmission systems. In particular, the present invention provides an optical integrator utilizing a photonic bandgap quasi-crystal architecture to connect optical devices within a single monolithic lightwave integrated circuit.

### BACKGROUND OF THE INVENTION

The present invention relates generally to optical devices for fiber communication, and more particularly, to optical devices that include photonic structures for spectrally selective connection of optical components.

The rapid rise in demand for high-capacity and efficient optical telecommunication in the past several years has created the need for enhanced wideband communications systems. Increasing the bandwidth of a telecommunications system by routing additional fiber optic cables, although feasible, is typically very expensive. An alternative cost-effective solution is to transmit multiple messages from a large number of information sources in one location to a large number of receivers in another location by utilizing multiple light wavelengths. Each individual stream of information, which emanates from a single information source, is typically denoted as a connection. In such a multi-connection communications system, connections associated with several information sources are combined (multiplexed), and transmitted as a composite signal over a single transmission line. At the receiver, the individual connections are separated (demultiplexed). Since each connection is assigned a pre-defined wavelength, such a communications method is generally known as wavelength division multiplexing (WDM). Although optical and/or opto-electronic components are generally needed to perform multiplexing and demultiplexing tasks, one important advantage of multiplexing communications systems is a reduction in the number of transmission lines for a given bandwidth, which can substantially reduce infrastructure costs.

A variety of optical and opto-electronic devices, such as, multiplexers, integrating elements, switches, lasers, modulators, photodiodes, optical isolators, circulators, and receivers are employed in wavelength division multiplexing systems. An integration of such optical and opto-electronic devices in the same monolithic lightwave circuit can improve the performance of WDM systems while simultaneously reducing manufacturing cost. Lithographic fabrication techniques, and planar lightwave circuits (PLC) are currently utilized, inter alia, for generating such integrated platforms. Conventional PLCs can, however, present a number of shortcomings. For example, optical elements of a conventional PLC are typically interconnected by utilizing ridge (rib) waveguides, which are analogs of wiring in electronic integrated circuits (K. Okamoto, Fundamentals of Optical Waveguides, Academic Press, 2000). Such ridge waveguides limit the possibility of two-dimensional light propagation. In fact, in ridge waveguides, light propagates in one dimension, e.g., forward and backward along the waveguide axis. Also, the ridge waveguides cannot intersect each other.

Arrayed Waveguide Grating (AWG) multiplexers and integrating elements present typical examples of PLCs having ridge waveguides. While AWG's do not demand the option for the ridge waveguides to cross in one plane, more complex integrated devices may require such crossings.

Photonic bandgap crystals have recently emerged as potential competitors for replacing ridge waveguides as connecting elements. (J. D. Joannoupoulos, R. Meade, and J. Winn. Photonic Crystals (Princeton U. Press, Princeton, N.J., 1995)). Photonic bandgap crystals use a planar periodic structure to create a range of wavelengths at which light cannot propagate through a planar waveguide and range of wavelengths (passbands) that are readily propagated. One disadvantage of photonic crystals is that the strong variation of refraction index necessary for wavelength differentiation in two directions leads to light scattering in a third direction. Another problem is crosstalk between connections at different wavelengths that the crystal allows to propagate.

Gratings can also be utilized to connect optical devices. For example, U.S. Pat. No. 4,923,271 issued on May 8, 1990 describes an optical MUX/DEMUX comprising cascaded elliptic Bragg reflectors (gratings). These gratings are formed in a planar waveguide by employing microlithography. Each grating is tuned to a definite light wavelength corresponding to one of the working channels. The gratings have one common focal point and different ellipticities such that the location of the remaining focus may be chosen so as to provide adequate spacing between the input and output ports.

However, the device described in U.S. Pat. No. 4,923,271 is not scalable to a high number of connections. The gratings are spatially separated for sequential processing of light in each of them. As the number of channels, and the number of corresponding wavelengths to be processed grow, the size of the device will increase, the path of light to the remote gratings, and consequently intrinsic losses, will grow. Further, manufacturing large devices is difficult and expensive due to limited precision of the lithographic process and uniformity of the planar waveguide used as a substrate for the gratings.

An example of integrated optical device is an Add/Drop Multiplexers (OADM) described by P. Kersten, F. Bakhti in Proceedings of SPIE, Vol. 4277 2001, Page 54, San Jose, USA. OADM usually includes an AWG as a demultiplexer, a thermooptical switching matrix, and an AWG multiplexer. Double passing of light through AWGs results in strong loss of about 3-10 dB.

Another example of an integrated optical device is a channel monitor required for dynamic control of the signals propagating in different channels of multichannel systems. Placing multiplexer/channel monitors/attenuators/demultiplexer on a single planar structure represents significant problems because of the need for multiple intersections of light connections.

Thus, there is a need for enhanced optical devices, such as, switches, multi-wavelength lasers, channel monitors, modulators, multiplexers/demultiplexers, that can be readily incorporated in integrated optical and opto-electronic devices for use in wavelength division multiplexing systems.

Further, there exists a need for integrating elements for planar lightwave circuits that allow a flexible planar layout of light beams such that the beams can cross one another in a plane and provide spectrally-sensitive connection of optical devices.

### SUMMARY OF THE INVENTION

A photonic multi-bandgap structure of the present invention, herein also referred to as photonic bandgap quasi-crystal (“PBQC”), can direct light, having wavelength components within a selected passband (Δλ), from an input port, to a predefined output port, while providing interconnecting and integrating element for Planar Lightwave Circuits. Photonic bandgap quasi-crystals can combine the spectrally selective properties of gratings, the focusing properties of elliptical mirrors, the superposition properties of thick holograms, the photonic bandgaps of periodic structures, and the flexibility of binary lithography on planar waveguides. In other words, a photonic bandgap quasi-crystal is a quasi-periodic structure with multiple periods and multiple, elliptically-shaped bandgaps. These photonic bandgap quasi-crystals can be made on planar waveguides from sub-wavelength features, herein referred to as “dashes”, with binary lithography. A dash can be, for example, an etched line segment having selected depth, width and length. A single photonic bandgap quasi-crystal provides many connections with different desirable transfer functions.

In one aspect, the present invention provides an optical device that includes an optical waveguide and a photonic multi-bandgap structure optically formed therein. The waveguide includes one or more input ports and a plurality of output ports, and allows transmission of light, having one or more wavelength components within a selected wavelength range, between these ports. The photonic multi-bandgap structure directs light having wavelength components in each passband region (Δλ), within the wavelength range that is transmissible through the waveguide, from pre-selected input ports to pre-selected output ports.

In another aspect, the photonic multi-band gap structure is formed of a plurality of reflective micro-elements disposed on a planar surface of the waveguide so as to form a quasi-periodic pattern. Each micro-reflective element provides a local modulation of the index of refraction of the planar surface on which it is disposed, and the micro-reflective elements collectively reflect light having wavelength components within a plurality of passband regions (Δλᵢ, i=1, . . . N) such that the reflections corresponding to each passband region Δλᵢ interfere on average constructively in a selected direction, for example, a direction associated with an output port of the optical device.

In a related aspect, the micro-reflective elements are disposed on a surface (x,y) of the waveguide at locations corresponding substantially to local maxima of a generating function A(x,y), representing a two-dimensional profile of refraction index as a linear superposition of a plurality of modulation functions each describing a separate sub-grating.

In one embodiment, the generating function A(x,y) is defined in accord with the relation:

$$A ( x , y ) ∼ {\sum }_{i = 1}^{i = N} {a}_{i} Sin ( 2 π ( 1 + f ( x , y ) ) {l}_{i} / {λ}_{i} + {ϕ}_{i} ) ,$$

wherein

i is an index that refers to a connection made between a selected input port and a selected output port,

lₗ=|\vec{r}ₗⁱⁿ|+|\vec{r}ᵢ^{out}|, wherein \vec{r}ₗⁱⁿ is a vector connecting the input port i to an arbitrary point (x,y) on the planar surface, \vec{r}ₗ^{out} is a vector that connects this point (x,y) with the output port i for a chosen wavelength λₗ,

αₗ is a weight coefficient associated with the connection i,

Φᵢ is an arbitrary phase associated with the connection number i,

and ƒ(x,y) is a function that compensates for variation of refractive index, as discussed in more detail below.

In a related aspect, the binary function B(x,y) can be defined in accord with the relation:

i B(x, y)=1, if A(x, y)>0

and

B(x, y)=0 otherwise.

In another aspect, in an optical device of the invention as described above, the micro-reflective elements are disposed on a surface of the waveguide in accord with a pattern defined by a function, herein referred to as C(x,y), that approximates the function B(x, y) as a plurality of discrete elements having pre-defined shapes and positions. The discrete elements can be, for example, “dashes” having pre-defined widths, depths and lengths.

In a related aspect, the micro-reflective elements provide quasi-periodic modulation of index of refraction of a surface of the waveguide. The micro-reflective elements can be, for example, any of a ridge, a groove, or a micro-location doped with a selected ion in a surface of the waveguide.

In further aspects, an optical device of the invention includes a substrate on which an optical waveguide is disposed as a stack of alternating low refractive index cladding and high refractive index core layers. A ratio of the index of refraction of core layer relative to that of cladding layer can be, for example, in a range of about 1.2 to about 2. The optical waveguide can be configured to be substantially transparent to radiation having wavelength components in a range of about 800 nm to about 1600 nm, and can also be configured for transmission of light having any of a TM or TE polarization modes. A photonic structure of the invention, as described above, can be formed in the waveguide for selectively directing wavelength components from an incident direction to a pre-defined output direction.

In other aspects, the invention provides an integrated multi-wavelength laser/optical modulator for use in a WDM system that includes a multi-wavelength laser, a plurality of modulators, and a multiplexer formed in a planar waveguide. The laser can include a lasing medium and a broadband mirror that is optically coupled thereto. A photonic multi-bandgap structure optically coupled to the lasing medium focuses each wavelength component of light emitted from the lasing medium to one of a plurality of pre-defined locations in the waveguide. The term “wavelength component” as used herein can refer to a specific wavelength λ, or alternatively a wavelength range (Δλ) spanned around the specific wavelength λ. The wavelength range (Δλ) is also herein referred to as a passband region. The integrated multi-wavelength laser/optical modulator further includes a plurality of mirrors, each of which is positioned at proximity of one of the pre-defined locations corresponding to a wavelength component at which said each mirror is at least partially reflective. Each wavelength sensitive mirror, together with the photonic structure, the lasing medium, and the broadband mirror, forms a lasing cavity for a particular wavelength, i.e., the wavelength at which the wavelength sensitive mirror is at least partially reflective.

In a related aspect, in an integrated multi-wavelength laser/optical modulator as described above, each partially reflective mirror allows transmission of a selected portion of light to generate an output signal, e.g., a laser signal, at a selected wavelength. A plurality of modulators, each of which receives an output signal associated with one of the partially reflective mirrors, modulates the output signals, and a multiplexer formed according to the teachings of the invention receives the modulated signals at a plurality of input ports and direct the signals to an output port.

In another aspect, the present invention provides a channel monitor and control device for use in a WDM system that includes a demultiplexer, formed in a planar waveguide, that employs a photonic multi-bandgap structure for directing each wavelength component of an input light signal to a pre-defined location in the waveguide. The device includes additional photonic multi-bandgap structures according to the teachings of the invention, each of which is positioned at proximity of one of the pre-defined locations to receive a selected wavelength component of input light reflected by the demultiplexer. Each of these additional photonic structures transmits a portion of the received light, and reflects a smaller portion of the received light to a pre-defined location in the waveguide. The device further includes a plurality of detectors each positioned to detect light reflected from one of said photonic multi bandgap structures and to generate an output signal in response to the detected light. A control circuit is electrically coupled to the detectors to receive the electrical signals, and to generate a plurality of control signals to be applied to a plurality of attenuators, each of which is optically coupled to one of the photonic multi-bandgap structures to receive the light transmitted by that structure. Each control signal sets the attenuation level of a corresponding attenuator.

In another aspect, the invention provides optical devices such as those described above in which crosstalk among various optical channels is substantially reduced by judicious positioning of the output ports. In particular, each output port is associated with one of the passband regions such that a location (\vec{R}ₗ) of an output port associated with passband region Δωₗ, having a central frequency ωₗ, and a location (\vec{R}ₗ) of an output port associated with another passband region Δωⱼ, having a central frequency ωⱼ, are substantially related as follows:

\vec{R}ₗ−\vec{R}ⱼ=δ\vec{R}(ωₗ−ωⱼ).

In another aspect, crosstalk is minimized by utilizing a generating function in accord with to the following relation:

$$A ( x , y ) = {\sum }_{i = 1}^{i = N} {a}_{i} Sin {Ψ}_{i} + P {\sum }_{i = 1}^{i = N} {\sum }_{j = 1}^{j = N} {\sum }_{k = 1}^{k = N} {a}_{i} {a}_{j} {a}_{k} Sin ( {Ψ}_{i} + {Ψ}_{j} - {Ψ}_{k} + {Ψ}_{0} )$$

wherein

Ψₗ=2π(1+ƒ(x, y))lₗ,|λₗ+Φₗ

and i, j, and k are indices that refer to connections made from the input port to different selected output ports,

Similar to previously defined generating function, lₗ=|\vec{r}ₗⁱⁿ|+|\vec{r}ₗ^{out}|, wherein \vec{r}ₗⁱⁿ is a vector connecting the input port i to an arbitrary point (x,y) on a planar surface of a waveguide, \vec{r}ₗ^{out} is a vector that connects this point (x,y) with the output port i for a chosen wavelength λₗ, and αₗ, αⱼ, αₖ are weight coefficients associated with the connections i, j, and k, respectively, and can be determined by experiment and/or simulation. Moreover, ƒ(x,y) is a function that compensates for variation of refractive index, as discussed in detail above. Further, P represents a pre-compensation coefficient, which can be negative or positive, and Ψ₀ represents an arbitrary phase shift. Both P and Ψ₀ can be determined by experiment and/or simulation in order to minimize crosstalk.

In yet another aspect, a linear chirp is applied to the optical path lengths utilized in a generating function according to the teachings of the invention to provide dispersion compensation. For example, a photonic multi-bandgap structure of the invention can be formed by utilizing a chirped generating function defined in accord with the following relation:

$$A ( x , y ) ∼ {\sum }_{i = 1}^{i = N} {a}_{i} Sin ( 2 π ( 1 + f ( x , y ) ) li ( 1 + h \frac{{l}_{i}}{{λ}_{i}} ) + {φ}_{i} )$$

wherein the index i refers to a connection made between a selected input port and a selected output port, lₗ=|\vec{r}ₗⁱⁿ|+|\vec{r}ₗ^{out} |, wherein \vec{r}_{;}ⁱⁿ is a vector connecting the input port i to an arbitrary point (x,y) on a planar surface of a waveguide, \vec{r}ₗ^{out} is a vector that connects this point (x,y) with the output port i for a chosen wavelength λₗ, αₗ is a weight coefficient associated with the connection i, Φᵢ is an arbitrary phase associated with the connection i, ƒ(x,y) is a function that compensates for variation of refractive index, and h is a chirp coefficient. The chirp coefficient h typically has small values (e.g., 10⁻⁵-10⁻⁶), and can be selected to compensate for positive or negative dispersion.

In another aspect, in an optical device of the invention as described above, compensation of a dispersion slope associated with a PBQC structure of the invention can be accomplished by splitting each sub-grating corresponding to a central frequency (ωᵢ

$$( \frac{1}{{λ}_{i}} )$$

to two sub-gratings corresponding to two frequencies symmetrically disposed about the wavelength ωᵢ. In other words, a generating function A(x,y) defined in accord with the following relation can be utilized:

$$A ( x , y ) ∼ {\sum }_{i = 1}^{i = N} [ {a}_{i}^{1} sin ( 2 π ( 1 + f ( x , y ) ) {l}_{i} ( \frac{1}{{λ}_{i}} + Δ ) + {φ}_{i}^{1} ) + {a}_{i}^{2} sin ( 2 π ( 1 + f ( x , y ) ) {l}_{i} ( \frac{1}{{λ}_{i}} - Δ ) + {φ}_{i}^{2} ) ]$$

wherein the index i refers to a connection made between a selected input port and a selected output port, lᵢ=|\vec{r}ᵢⁱⁿ|+|\vec{r}ᵢ^{out} |, wherein \vec{r}ᵢⁱⁿ is a vector connecting the input port i to an arbitrary point (x,y) on a planar surface of a waveguide, \vec{r}ᵢ^{out} is a vector that connects this point (x,y) with the output port i for a chosen wavelength λᵢ, αₗ¹ and αₗ² are weight coefficients associated with two members of a pair of sub-gratings corresponding to the wavelength λₗ, Φₗ is an arbitrary phase associated with the connection i, ƒ(x,y) is a function that compensates for variation of refractive index, and Δ is a parameter indicating separation of a frequency associated with each member of the pair from the frequency

$$\frac{1}{{λ}_{i}} .$$

The value of Δ can be, for example, approximately 20% of the channel spacing. The channel spacing can be, for example, 100 GHz.

In yet another aspect, a photonic structure of the invention includes first and second portions such that, for each two neighboring passband regions, the first portion directs light having wavelength components within one of the neighboring regions to a selected one of the output ports of a planar waveguide in which the photonic structure is formed, and the second portion directs light having wavelength components within the other of the neighboring regions to another selected one of the output ports. This advantageously maximizes bandwidth utilization while ensuring that crosstalk remains within acceptable levels. The first and the second portions can be independently apodized.

In further aspects, at least one pair of first and second photonic multi-bandgap structures are formed in the same waveguide as a plurality of micro-reflective elements according to the teachings of the invention such that, for each of a selected set of passband regions, the pair of structures cooperatively directs light having wavelength components within the passband region from an input port to at least one pre-selected output port. In particular, one member of the pair can receive light from the input port of the optical device and can reflect the received light to the other member, which in turn reflects the light to the pre-selected output. The structures are preferably designed to have flat top transfer functions such that the transfer function of the combination, which can be represented by a product of the transfer functions of individual members, advantageously exhibits flat top and low crosstalk among various optical channels.

In another aspect, the weight coefficients (αᵢ) in the generating function can be selected for each optical channel, that is, for each passband region being directed from an input port to a pre-selected output port, such that each optical channel has a desired bandwidth independent of the bandwidths of the other channels. For example, two different channels can have two different bandwidths.

More particularly, the bandwidth (Δƒᵢ) of a frequency channel associated with a sub-grating having a weight coefficient αᵢ is related to the respective weight coefficient in accord with the relation:

Δƒₗ=καₗ

wherein κ is a proportionality constant. Accordingly, the bandwidth of an optical channel can be varied by adjusting the value of the associated weight coefficient.

In another aspect, the invention provides an optical device that includes a planar waveguide formed at least of a core layer and a cladding layer, and a photonic multi-bandgap structure formed in the waveguide according to the teachings of the invention. The planar waveguide allows transmission of both a TE (transverse electric) and a TM (transverse magnetic) modes. The thickness of the core layer is advantageously selected such that a birefringence of the TE (transverse electric) and TM (transverse magnetic) modes induced by mechanical stress is substantially compensated by a birefringence induced between these two modes by the waveguide planar geometry. For example, the thickness of the core layer can be selected to be in a range of about 3 microns to about 6 microns.

In another aspect, a planar waveguide utilized in a device of the invention can transmit light with TE or TM polarizations having one or more passband regions within a selected frequency range (Δω) centered about frequency ω between an input port and a plurality of output ports while exhibiting effective refraction indices associated with the TE mode γ_{E} and the TM mode γ_{M} that are related to one another in accord with at least one of the following relations:

$$\frac{{γ}_{E} - {γ}_{M}}{{γ}_{E}} > \frac{Δ ω}{ω} , or$$

$$\frac{{γ}_{E} - {γ}_{M}}{{γ}_{E}} > 2 \frac{Δ ω}{ω} .$$

In another aspect, in an optical device of the invention as described above, the photonic multi-bandgap structure is formed as a plurality of micro-reflective elements disposed on a surface of a planar waveguide such that a spacing between any two neighboring micro-reflective elements is substantially one-half of the wavelength of light within a selected passband region that is transmitted through the waveguide.

In another aspect, each micro-reflective element is formed on a surface of the waveguide by etching a portion of the surface to a depth that is substantially equal to one half of the wavelength of light within a selected passband region that is transmitted through the waveguide.

Further understanding of the invention can be obtained by reference to the following detailed description and associated drawings, which are described briefly below.

### BRIEF DESCRIPTION OF THE DRAWINGS

FIG. 1 schematically depicts the functionality of an optical device of the invention,

FIG. 2 shows an optical device according to the teachings of the invention, fabricated on a planar optical waveguide,

FIG. 3 is an exemplary depiction of a two-dimensional generating function A(x,y) utilized in the first step of a method of the invention for generating a photonic multi-gap structure according to the invention,

FIG. 4 is an exemplary depiction of a binary function B(x,y) that approximates the generating function A(x,y),

FIG. 5 is an exemplary depiction of a plurality of discrete elements disposed on a surface in accord with a pattern defined by a function C(x,y) generated in a method of the invention as a discretized approximation of the binary function (x,y),

FIG. 6 shows the discrete elements of FIG. 5 with selected ones of the discrete elements removed,

FIG. 7 is a schematic exemplary diagram of dispersion characteristics of a photonic structure of the invention that is characterized by the presence of a multiplicity of bandgaps,

FIG. 8 shows exemplary experimental data obtained from a proto-type of an optical device of the invention having a 4-channel PBQC in which provisions for minimizing cross-talk among the channels are provided in accordance with the teachings of the invention,

FIG. 9 shows an exemplary channel monitor and control device formed according to the teachings of the invention for use in a WDM system,

FIG. 10 illustrates another embodiment of the device of FIG. 9,

FIG. 11 illustrates an integrated multi-wavelength laser/modulator for use in a WDM system formed in accordance with the teachings of the invention,

FIG. 12A illustrates simulated transfer function of a 4-channel PBQC demultiplexer according to the teachings of the invention with low channel isolation,

FIG. 12B illustrates experimentally measured transfer function corresponding to the demultiplexer of FIG. 12A,

FIG. 13 illustrates a plurality of wavevectors associated with photonic structure of the invention designed to direct light from an input port to a plurality of output ports positioned relative to one another so as to minimize crosstalk,

FIG. 14 illustrates a simulated transfer function for a 4-channel PBQC of the invention, such as the device of FIG. 8, in which provisions for minimizing cross-talk among the channels are provided in accordance with the teachings of the invention,

FIG. 15 depicts a profile of an apodizing function having a central portion that is utilized for apodizing chirped sub-gratings formed in accordance with the teachings of the invention,

FIG. 16 schematically illustrates movement of effective reflection point as function of light frequency in a PBQC of the invention in which provisions for dispersion slope compensation are provided in accordance with the teachings of the invention,

FIG. 17 illustrates three passband regions and their associated bandwidths and channel spacings,

FIG. 18 schematically depicts a PBQC structure of the invention having two portions, one of which directs light corresponding to even channels and the other directs light corresponding to odd channels from an input port to pre-selected output ports,

FIG. 19 illustrates three PBQC structures of the invention formed in a single planar waveguide to provide two pairs of cascaded structures,

FIG. 20 illustrates an optical device of the invention that includes a planar waveguide having a core layer, sandwiched between a lower and an upper cladding layer, and a PBQC structure formed at an interface of the core and the upper cladding layer,

FIG. 21 illustrates an optical device of invention having a PBQC formed in a planar waveguide having a core layer that is formed of a semiconductor material,

FIG. 22 illustrates a planar waveguide in an optical device of the invention having a core layer, sandwiched between two cladding layers, in which a PBQC structure is formed sufficiently distinct from the core-cladding interfaces so as to suppress scattering into radiating modes, and

FIG. 23 illustrates the intensity profiles of a core mode and a radiating mode that can travel through a planar waveguide of an optical device of the invention.

### DETAILED DESCRIPTION

The present invention provides a photonic multi-bandgap structure, herein also referred to as photonic bandgap quasi-crystal (“PBQC”), that can direct light, having wavelength components within a selected passband (Δλ), from an input port, to a predefined output port, while providing an integrating element for Planar Lightwave Circuits. A photonic bandgap quasi-crystal of the invention combines in a planar waveguide spectrally selective properties of gratings, focusing properties of elliptical mirrors, superposition properties of thick holograms, photonic bandgaps of periodic structures, and flexibility of binary lithography. A photonic structure of the invention can be utilized, for example, as an integrated spectrally sensitive element in a variety of optical devices that can include, but are not limited to, optical switches, optical multiplexer/demultiplexers, multi-wavelength lasers, and channel monitors in Wavelength Division Mulitplexing (WDM) telecommunications system.

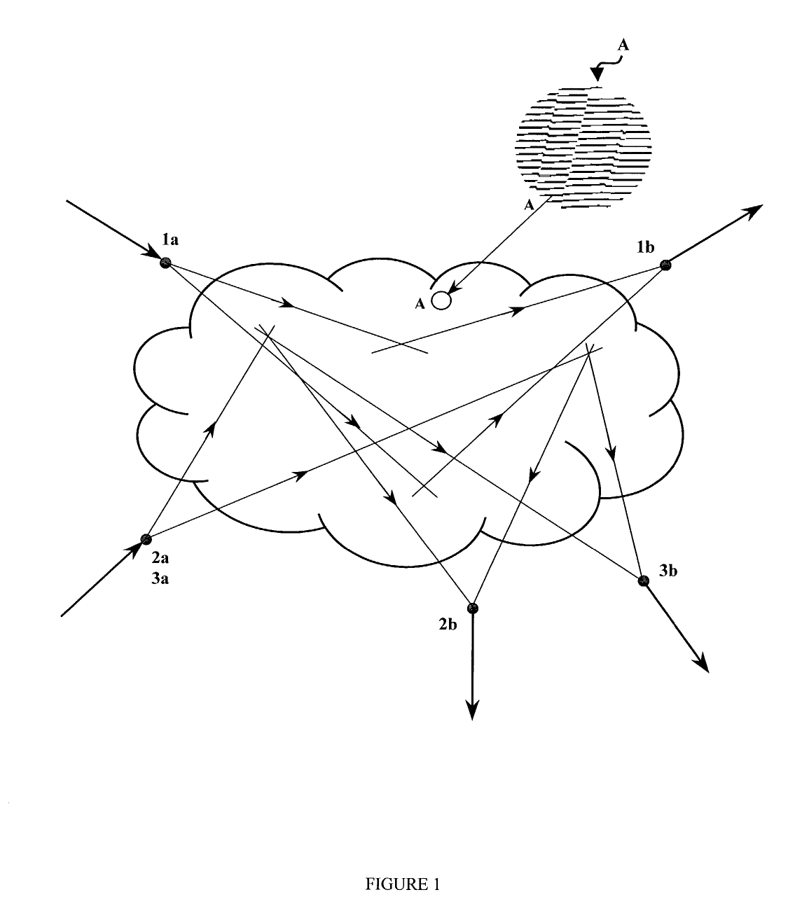

FIG. 1 illustrates schematically the general functionality of optical devices that can be formed according to the teachings of the invention. In particular, such optical devices can include mirco-reflective elements A positioned on a surface in accord with the teachings of the invention, as described in detail below, to form a quasi-periodic pattern to allow selectively directing an input signal, such as signals 1a, 2a, and 3a, received via input ports to a pre-defined output port based on the wavelength, or more generally passband (Δλ), of the input signal, to form an output signal, such as signals 1b, 2b, and 3b corresponding to the input signals 1a, 2a, and 3a, respectively.

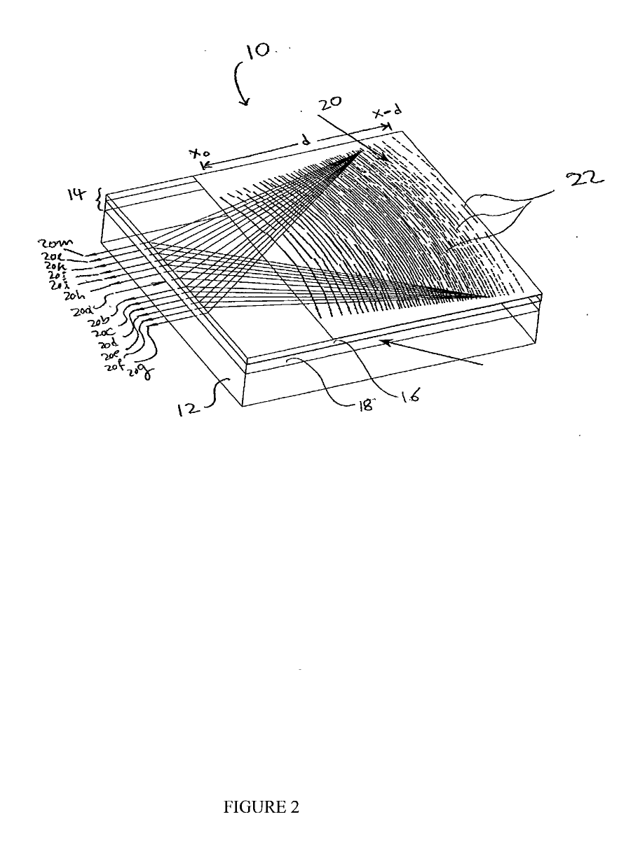

FIG. 2 shows an exemplary optical device 10 according to the teachings of the invention that includes a substrate 12 on which a planar waveguide 14 is disposed. The waveguide 14 is preferably substantially transparent to light having one or more wavelength components in a selected wavelength range, e.g., about 800 nm to about 1600 nm, and comprises at least two layers: a lower cladding and a core. It can also include an upper cladding layer. In addition, the core can include several layers. The core refractive index is preferably greater than the indices of both cladding layers, resulting in confinement of light by cladding layers and guiding it along the core.

The exemplary waveguide 14 is formed of a core 16 and a cladding 18, and further includes a plurality of optical ports 20a, 20b, 20c, 20d, 20e, 20f, 20g, 20h, 20i, 20j, 20k, 20l, and 20m, herein collectively referred to as optical ports 20, that allow coupling light to the waveguide layer. Although this exemplary waveguide 14 includes one cladding layer, namely, the layer 18, other waveguides suitable for use in the optical device 10 can include another cladding layer disposed over the core layer 16, or a plurality of alternating cladding and core layers.

In this exemplary embodiment, the port 20a functions as an input port for coupling radiation into the waveguide 14 and the ports 20b-20m function as output ports for transmitting radiation from the waveguide 14 to the outside environment, for example, to other optical or optoelectronic components of a device in which the optical device 10 is incorporated. Those having ordinary skill in the art will appreciate that this distinction between the port 20a and the ports 20b-20m is arbitrary and any of these ports can be configured as an input port or an output port. Further, the number of ports in a device of the invention can be more or less than that shown in this exemplary embodiment.

The optical device 10 further includes a photonic multi-bandgap structure 20 according to the teachings of the invention, which is formed of a plurality of reflective micro-elements 22 in a manner described in more detail below. The exemplary photonic structure 20 is formed on a planar surface of the optical waveguide 14, for example, at an interface of the cladding 18 with the core 16. It can also be formed at other interfaces inside or outside of the waveguide, provided that the light mode propagating through the waveguide has a significant amplitude at the location where the described photonic structure is formed. In general, the photonic structure 20 is formed in such a way so as to optimize optical coupling of light traveling through the waveguide 14 thereto.

The photonic structure 20 directs light having wavelength components within a selected passband region (Δλ), which is encompassed within the wavelength range in which the waveguide is substantially transparent, from a selected one or more of the ports 20a-20m to other pre-defined one or more of these ports. For example, the photonic structure 20 can be designed to transmit light within one passband region Δλ₁ from the input port 20a to the output port 20c, and to transmit light within another passband region Δλ₂ from the input port 20a to another output port 20h.

With continued reference to FIG. 2, the exemplary micro-reflective elements 22 form a quasi-periodic pattern, herein referred to as “quasi-crystal”, such that the photonic multi-bandgap structure exhibits a dispersion function characterized by a plurality of bandgaps. Each bandgap effects reflection of light, having wavelength components within a selected passband region, and incident on the photonic structure along a selected input direction, to an output direction that forms a pre-defined angle relative to the input direction. In other words, the photonic structure 20 can form an optical connection between two points, for example, an input point and an output point, such that any wavelength component within a selected passband region is transmitted from the input point to the corresponding output point. The transfer function of each optical connection can be individually tailored.

As discussed above, the micro-reflective elements 20 form a pre-determined planar quasi-periodic pattern of sub-wavelength features. Positions of features are carefully chosen to optimize transfer functions of all connections. In a method of the invention for generating a quasi-periodic pattern, in an initial step, a generating function A(x,y), which resembles a superposition of a plurality of interference fringes of pairs of diverging and converging light beams, is defined in accord with the relation:

$$A ( x , y ) ∼ {\sum }_{i = 1}^{i = N} {a}_{i} Sin ( 2 π ( 1 + f ( x , y ) ) {l}_{i} / {λ}_{i} + {ϕ}_{i} ) , \qquad Eq . ( 1 )$$

wherein the index i refers to a connection made between a selected input port and a selected output port, lₗ=|\vec{r}ₗⁱⁿ|+|\vec{r}ₗ^{out}|, wherein \vec{r}ₗⁱⁿ is a vector connecting the input port i to an arbitrary point (x,y) on the planar surface, \vec{r}ₗ^{out} is a vector that connects this point (x,y) with the output port i for a chosen wavelength λₗ, αₗ is a weight coefficient associated with the connection i, and Φₗ is an arbitrary phase associated with the connection number i, and ƒ(x,y) is a function that compensates for variation of refractive index, as discussed in more detail below.

The coefficient αₗ can be determined, for example, by simulation or experimentally, so as to obtain a desired transfer function for each optical connection. For example, all channels are polled to define αᵢ value so as to obtain constructive interference for as many channels as possible.

Each term in the summation defining the function A(x,y) corresponds to a distinct sub-grating. That is, each term by itself provides a set of elliptical grating lines that can function as a Bragg reflector at a particular wavelength. The summation superimposes these sub-gratings such that constructive reflections can occur for light having wavelength components within a plurality of passband regions, as discussed in more detail below.

As mentioned above, the function ƒ(x, y) is utilized in the above Equation (1) to compensate for variation of average effective refraction index. In the first approximation, the function ƒ(x, y) can be selected to be identically zero for all values of x and y. That is, the above Equation (1) can be utilized without any compensation for variation of the average effective refraction index. However, the variations in the refraction index of those regions of the waveguide 14 in which the photonic structure 20 is disposed can lead to undesirable distortions. Thus, in more preferred embodiments of the invention, the function ƒ(x, y) is defined in accord with the following relation:

ƒ(r)=1+Δn/n E 8. (2)

wherein r=\sqrt{x²+y²}, and Δn represents an average variation of the effective index of refraction in the vicinity of a point (x,y). It is a natural assumption that Δn/n can be linearly proportional to an apodizing function. An example of an apodizing function is discussed in more detail below.

If index of refraction of a planar waveguide, such as, the above waveguide 14, can be modulated in accordance with the above generating function A(x,y), each sub-grating, can create constructive interference for an optical connection formed between corresponding input and output ports at pre-selected wavelengths. A set of points for each connection i that provide the same phase for the sine function in the above equation, that is, those points that satisfy the following constraint:

lᵢ[1+ƒ(x, y)]=const (3)

lie on a circumference of an ellipse whose two foci can correspond, for example, to an input port and an output port, respectively.

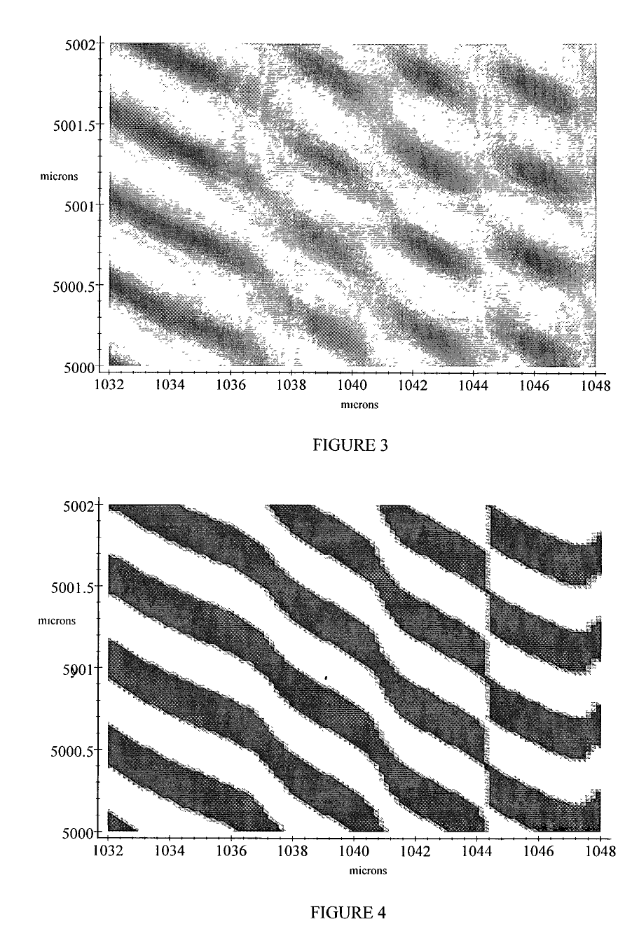

FIG. 3 provides an exemplary depiction of the generating function A(x,y). As shown in this figure, although each individual term in the sum forming the function A(x,y) corresponds to an elliptical sub-grating, no individual ellipses are evident in this figure because the summation results in overlaying multiple elliptical sub-gratings.

The generating function A(x,y) defines a rather complex two-dimensional relief with sub-micron features whose fabrication, for example, by utilizing lithographic techniques, is prohibitively difficult. Thus, in another step in a method for generating a photonic structure according to the teachings of the invention, the function A(x,y) is simplified by conversion into a binary function B(x,y) in accordance with the following relation:

B(x, y)=1, if A(x, y)>0 and Eq.(4)

B(x, y)=0 otherwise.

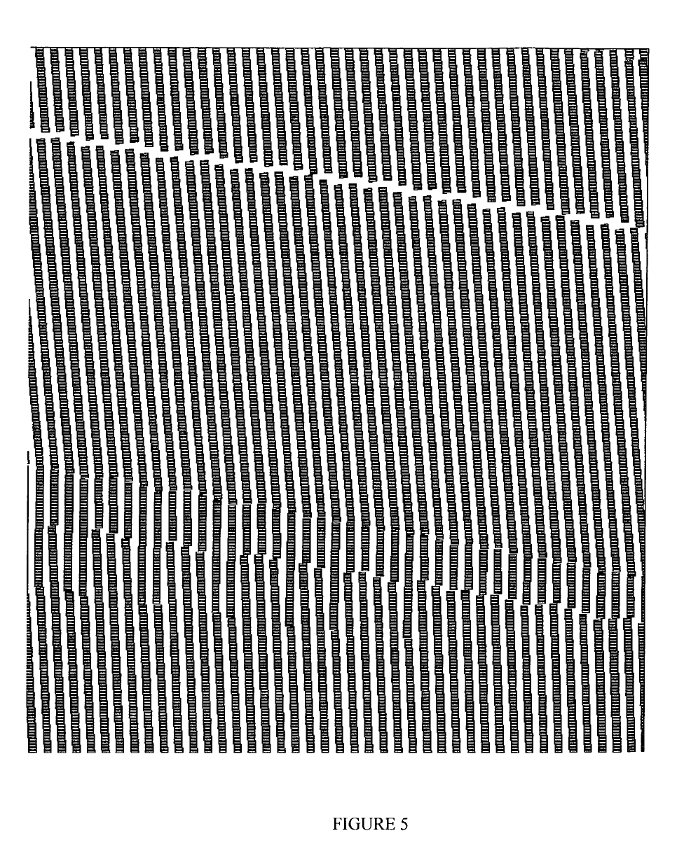

FIG. 4 depicts one example of the above function B(x,y), which resembles a warped chessboard.

The binary function B(x,y), though simplified relative to the function A(x,y), remains nonetheless typically too complex to be implemented as a relief on a planar surface. Thus, in preferred embodiments of the invention, the function B(x,y) is approximated by another function, herein referred to as C(x,y), as a plurality of discrete elements, for example, straight dashes of standard width or polygons. To maximize the reflections, it is preferable to select the width of a dash close to ¼ of the light wavelength propagating through the device. Also, the individual dashes should not touch each other. With these conditions observed, the two-dimensional relief described with the function B(x,y) is approximated with multiple individual dashes, locations and orientations of which are determined by the best fit to B(x,y). The best fit can be found by several standard methods, for example, the difference between B(x,y) and C(x,y) may be minimized by a least squares method.

FIG. 5 provides an exemplary illustrations of a surface topography created by the function C(x,y). It should be noted that FIG. 5 is included simply for illustrative purposes. As seen in FIG. 5, C(x,y) represents a plurality of discrete elements (“dashes”) having selected widths, depths, and positions. The dashes defined by the function C(x,y) can be implemented as discrete micro-reflective elements to generate a photonic structure of the invention, as described below.

It is known that Bragg gratings can exhibit side lobes as a result of light reflection from front and back ends of the gratings, where large gradients of effective refraction indices can be created. This effect can be ameliorated by smoothing, e.g., apodizing, the front and the back ends of the gratings. In some embodiments of the invention, an apodizing function is utilized to smooth the variations of effective refractive index over a planar photonic structure generated in accordance with the teachings of the invention. For example, the following apodizing function in accord with the following relation can be utilized:

$$g ( r ) = {cos}^{2} \{ π [ \frac{( r - {r}_{0} )}{( d - {r}_{0} )} - \frac{1}{2} ] \} for {r}_{0} < r < {r}_{0} + d \qquad Eq . ( 5 )$$

g(r)=0 otherwise,

where d is the super-grating length, r=r₀ and r=r₀+d correspond to the front and back ends of the super-grating, respectively. (See FIG. 2). The above function g(r) corresponds to zero modulation of the index of refraction everywhere other than in an area spanned by the PBQC structure. Within the PBQC structure, the above function g(r) varies smoothly from zero (no modulation) to unity (maximum modulation) at the center of the PBQC structure, and then smoothly drops to zero at the back end of the structure. In other words, full modulation occurs at the center of the structure that is surrounded by areas in which modulation varies from zero to a maximum value or vice versa. The function g(r) can be incorporated in the above generating function A(x,y) by defining the above function ƒ(r) in terms of the function g(r) in accord with the relation:

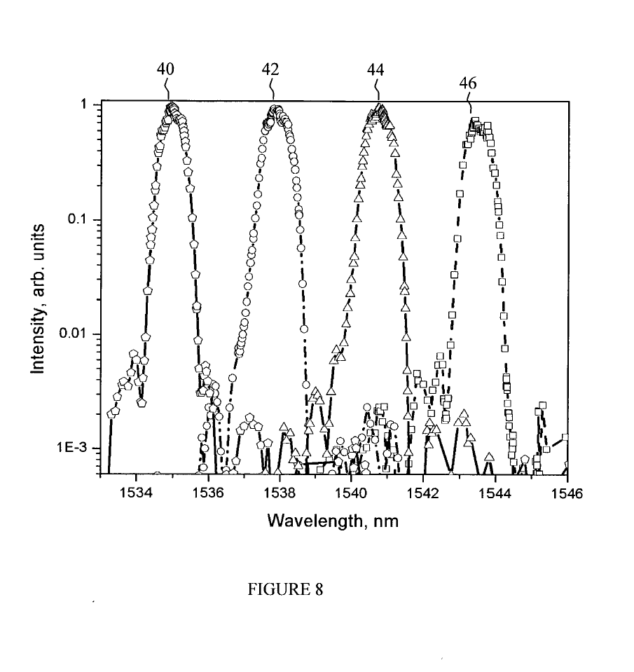

ƒ(r)=1+ag(r) Eq. (6).

wherein α is a selected constant. The constant α can be selected, for example, either experimentally or by simulation, to obtain an optimal fit between a transfer function associated with optical connections formed by the device and desired transfer function for those connections. For example, simulations were used to choose parameters for a proto-type optical device formed in accordance with the teachings of the invention for which experimental data are presented in FIG. 8.

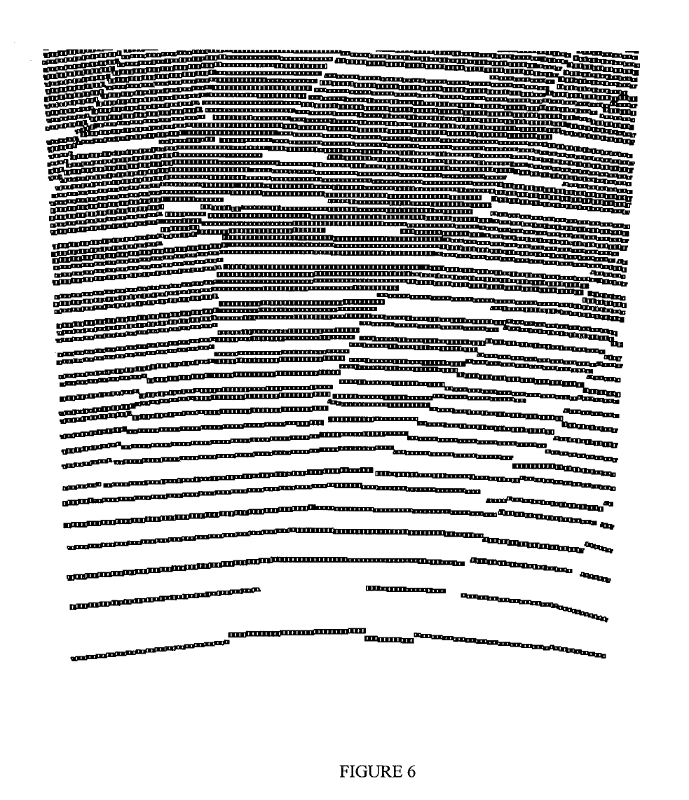

Further, the apodization of the PBQC structure can be implemented by varying the density of the micro-reflective elements such that the average density of the elements varies in a continuous manner from the front end of the photonic structure to the backend of the structure. Preferably, the density of the microelements reaches a maximum at the center of the photonic structure and decays on both sides of the maximum in a smooth fashion. For example, the pattern of dashes shown in FIG. 5 can be apodized by selective removal of some of the dashes, as shown in FIG. 6.

Referring again to FIG. 2, the plurality of the discrete micro-reflective elements 20 can be generated, for example, in the form of grooves or ridges, on a planar surface of the waveguide 14, for example, on a top surface of the core layer 16, in accord with the pattern of discrete elements, e.g., dashes having predetermined width and depth. Positions of the dashes are provided by the above function C(x,y).

A variety of techniques known in the art can be utilized to generate the micro-reflective elements. These techniques modulate the effective refraction index of a waveguide, resulting in Fresnel reflection from boundaries between zones characterized by different values of refractive indices. Typically, this modulation is produced by variation of the thickness of one or more layers of the waveguide or by doping some waveguide zones to change their refractive index.

For example, direct e-beam writing can be employed to expose a photoresist layer on a planar surface to generate a pre-defined pattern of grooves or ridges, each of which corresponds to one of the above micro-elements. For example, a computer-aided-machining (CAM) system of an electron beam apparatus can be loaded with instructions corresponding to the locations of the micro-reflective elements corresponding to a discrete pattern generated in accord with the teachings of the invention, for example, the above function C(x,y). These instructions can then be employed to move the electron beam in a controlled manner over a substrate surface to generate the micro-reflective elements 22 (FIG. 2). Then, the photoresist can be developed and the surface etched.

Alternatively, photo-lithographic techniques can be employed to generate a pattern of discrete micro-elements in accord with the teachings of the invention. In addition, the discrete elements are not limited to grooves or ridges, but alternatively, they can correspond to micro-locations in which a selected dose of an ion is implanted in a substrate to cause a local variation of index of refraction. In fact, any technique that can generate a pattern of refractive index variations in accord with the teachings of the invention, for example, in accord with the pattern provided by the above function C(x,y), or function B(x,y), or function A(x,y) can be employed to practice the invention.

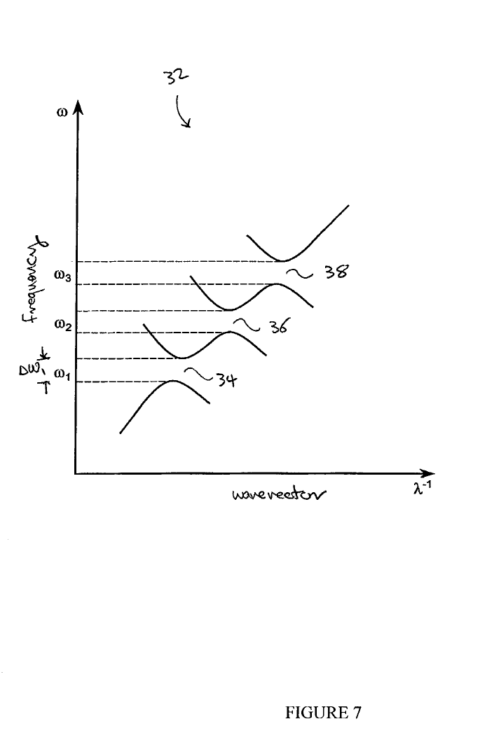

The selective directional response of a PBQC structure of the invention as a function of wavelength of incident light, or more particularly, as a function of a plurality of passband regions in a wavelength range can be better understood by reference to an exemplary schematic dispersion diagram 32, shown in FIG. 7. It should be understood that the dispersion diagram 32 is provided only for illustrative purposes and does not necessarily accurately depict the actual dispersion characteristics of a photonic structure of the invention. Further, although the exemplary dispersion diagram 32 is one-dimensional, those having ordinary skill in the art will appreciate that an actual dispersion curve of a photonic structure of the invention can be three-dimensional in wave vector (λ⁻¹) space. The diagram 32 shows that a photonic structure of the invention can include a multiplicity of bandgaps, such as, exemplary bandgaps 34, 36, and 38. Each bandgap can effect the reflection of light within a frequency range corresponding to that bandgap. For example, the bandgap 34 is centered around a frequency ω₁ and spans a passband region Δω₁ whereas the bandgap 36 is centered around a different frequency ω₂ and spans another bandpass region Δω₂. Hence, the bandgap 34 effects reflection of light within the passband region Δω₁ whereas the bandgap 36 effects reflection of light within the passband region Δω₂.

As discussed above, as the wavelength of the light incident on the PBQC structure varies within each passband region, for example, Δω₁, the direction of the output light generated by the photonic structure in response to the incident light remains fixed. That is, the PBQC structure of the invention focuses light with any wavelength within a selected passband region to the same point.

Referring again to FIG. 2, the base 12 and the planar waveguide layer 14 of the exemplary optical device 10 of the invention can be formed of a variety of different materials. For example, in one embodiment, the base 12 can be formed of silicon, and the core 16 of the waveguide 14 can be formed, for example, of optical quality silicon, or silicon oxide (SiO₂), or SiON, or Si₃N₄. Further, the cladding layer 18 can be formed of SiO₂. In this embodiment, the core 16 can have a thickness in a range of about 0.01 microns to about 6 microns, and the cladding layer 18 should be thicker than 12 microns to prevent the leakage of light from the core to the substrate. Those having ordinary skill in the art will appreciate that materials other than those described above can be utilized to form an optical device of the invention. Further, the thickness of the substrate, the core and the cladding layers can be different than the exemplary values provided above to suit a particular application of the optical device 10. Further, an optical device of the invention can have an additional cladding layer disposed on the core layer 16, or can include multiple alternating layers of core and cladding.

It is well known that planar waveguides can support electromagnetic waves of two different polarizations, namely, TE-mode and TM-mode. Photonic multi-bandgap structures of the invention, and devices in which such photonic structures are incorporated, such as the optical device 10 (FIG. 2) can be designed to be utilized simultaneously with both TE and TM light polarizations while exhibiting negligible polarization dependent loss (PDL). For example, with reference to FIG. 2, the core 16 and the cladding 18 of the waveguide layer 14 can be formed of separate materials having significantly different refraction indices. For example, for the core 16 having an average index of refraction (n), the cladding can be selected to have an index of refraction in a range of about 0.5 n to about 0.8 n. Some suitable materials having significantly different refraction indices for formation of the core and the cladding can include, but are not limited to, silicon, silicon oxide (SiO₂), SiON, Si₃N₄, InP, Ta₂O₅. The significant difference in refraction indices of the core and the cladding results in significant difference in the effective refraction indices for the TE and TM polarizations. The difference in effective refraction indices of TE and TM modes should be sufficiently large to avoid reflection of TE modes due to gratings associated with TM modes and/or reflection of TM modes from gratings associated with TE modes for a given working bandwidth. In particular, according to one embodiment, the following relationship is observed:

$$\frac{{γ}_{E} - {γ}_{m}}{{γ}_{E}} > 2 \frac{Δ ω}{ω}$$

where γ_{E} is the effective index of refraction for the TE mode and γ_{M} is the effective index of refraction of the TM mode.

Δω is the spectral range of a WDM system, and ω is, e.g., central wavelength with the spectral range Δω.

If mutual transformation of TE and TM modes can be neglected, the above condition may be relaxed as follows:

$$\frac{{γ}_{E} - {γ}_{m}}{{γ}_{E}} > \frac{Δ ω}{ω}$$

This allows for writing separate sub-gratings for TE and TM polarizations of light. For example, if the difference in the effective refraction indices for the TE and TM polarizations is 5%, then the TM polarization will be additionally reflected from the TE sub-grating with 5% shift in frequency. This additional reflection will not degrade performance of the optical device because only about 2% bandwidth is typically used in modern lightwave communication. Thus, the additional reflection does not lie in the working bandwidth. Another problem is that TE and TM polarization reflection coefficients are typically different (the difference is about 5-20%). This problem can be resolved by 5-20% variations in the coefficients aₗ in the above Equation (1) to compensate for the different reflection coefficients of the TE and TM polarizations. This approach is feasible because coefficients αᵢ control the reflectivity.

A photonic multi-bandgap structure can be created with binary micro-reflective elements by at least two different ways, by a simple superposition or synergetically. A simple superposition of many single-bandgap structures evidently creates photonic multi-bandgap structures. The drawbacks of the simple superposition are mutual interaction of the bandgaps, which can create undesirable reflections, and weak reflectivity because every micro-reflective element works for only one channel. A photonic multi-bandgap structure of the invention, herein also referred to as photonic bandgap quasi-crystal, exhibits a synergetic effect. That is, each micro-reflective element reflects light from a plurality of passband regions in different directions corresponding to different passbands, so that the reflections from other micro-reflective elements interfere constructively corresponding to these plurality of passband regions. In other words, before placing a micro-reflective element, the generating function A(x,y) polls all channels and then places the element to satisfy constructive interference for as many channels as possible. The element efficiency is proportional to the value of A(x,y) at the element position.

The synergetic property of a photonic structure of the invention provides a number of advantages relative to structures formed as simple superposition of rarified sub-gratings. In particular, the generating function A(x,y) has an average absolute value of approximately \sqrt{N}. In other words B(x,y) and, consequently, micro-reflective elements, create constructive interference for approximately \sqrt{N} connections, whereas in the case of a superposition of rarified sub-gratings, each connection works independently. As a consequence, for a synergetic photonic bandgap structure of the invention, and a superposition of rarified sub-gratings having the same number of optical connections N, and having the same number of etched microelements with the same depth and the same fraction of etched surface area (e.g., about 50%), the bandgap of the photonic structure of the invention (W_{syn}) is approximately \sqrt{N} wider than the bandgap of the superposition of ratified sub-gratings (Wₛᵤₚ). In other words, W_{syn}=\sqrt{N}Wₛᵤₚ.

An optical device of the invention, such as the exemplary optical device (FIG. 1), can be utilized in a variety of different applications. In one application, such an optical device can be employed as an optical multiplexer/demultiplexer. For example, with reference to FIG. 2, the optical device 10 can function as a demultiplexer in which the input port 20a receives light having a plurality of wavelength components, or more generally, a plurality of passband regions. The photonic structure 20 directs each wavelength component, or each passband region, to one of the output ports 20b-20m, thereby separating different wavelength components. Connections made by the quasi-crystal may be tailored for a specific device. For a demultiplexer, a low crosstalk can be achieved by applying apodization, and polarization dependent loss can be minimized by writing independent sub-gratings for TE and TM modes and tuning the coefficients αₗ.

Alternatively, the optical device 10 of the invention can function as a multiplexer by utilizing the ports 20b-20m as input ports and the port 20a as an output port. In this case, each port 20b-20m receives light having a selected wavelength, or more generally, wavelength components within a selected passband region Δλ. The photonic structure 20 reflects the light received from each port 20b-20m to the port 20a. Cross talk does not pose a problem in a multiplexer. Thus, a multiplexer can be formed without a need for apodization. The absence of apodization makes effective reflection of sub-grating higher at a fixed length of the PBQC structure, thus diminishing loss of light.

To illustrate the feasibility of manufacturing a PBQC optical device according to the invention, FIG. 8 presents experimental data corresponding to a prototype optical device based on the exemplary device 10 (FIG. 2). This prototype demultiplexer includes an input port for receiving light having wavelengths spanning a range from about 1530 nm to about 1550 nm, and four output ports. The experimental data shows four signals 40, 42, 44, and 46, each of which is associated with one of the output channels. As evident in the figure, each output signal corresponds to a distinct passband region. As seen in the experimental data, this proto-type device exhibits some cross-talk between the channels. The cross-talk is suppressed relative to the signal level by a factor of approximately 28 dB. It should be understood that this experimental result is presented only to show the feasibility of constructing an optical device according to the invention, and is riot intended to present optimal parameters, e.g., optimal suppression of cross-talk of a such a device.

As mentioned above, optical devices of the invention can find a variety of applications. Optical multiplexer/demultiplexers in accordance with the teachings of the invention can be employed, for example, in telecommunication systems that employ wavelength division multiplexing (WDM) for transmission of digital data. In such a system, an optical fiber carrying information in multiple communications channel, where each channel is associated with a particular wavelength range (passband region), can be coupled to the input port 20a (FIG. 2). The photonic structure 20 separates the light corresponding to different channels such as the light for each channel is directed to one of the output ports.

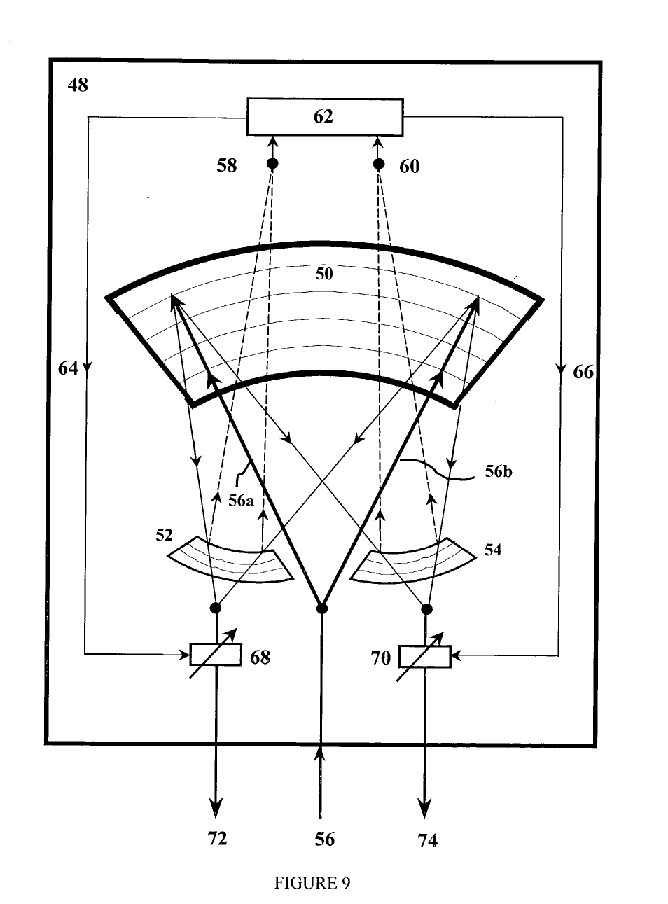

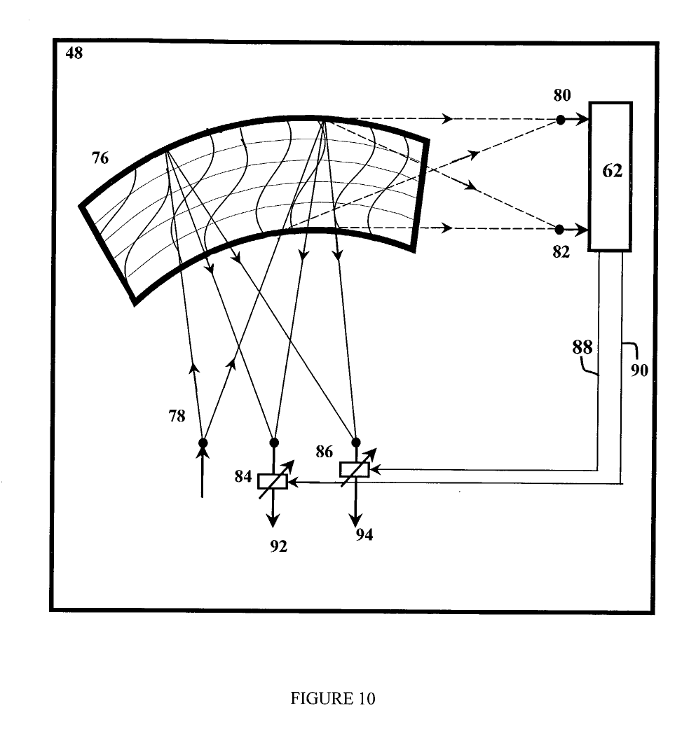

Another possible application of the optical devices of the invention relates to devices for monitoring and dynamic control of the signals propagating in different channels of the multichannel systems. As shown in FIG. 9, one such exemplary device 48 combines an optical demultiplexer 50 formed in accordance with the teachings of the invention with two PBQC structures 52 and 54, which are also formed in accordance with the teachings of the invention, to monitor and control signals in a multi-channel system, as described below. In particular, the device 48 receives an input light signal 56 that illuminates the demulitplexer 50 with a plurality of light rays in a solid angle schematically depicted by two edge rays 56a and 56b.

The demultiplexer 50 selectively reflects one passband region towards the PBQC structure 52, and another passband region to the other PBQC structure 54. Each PBQC structure is designed so that a small fraction of the light signal at the corresponding wavelengths is selectively reflected and focused at the predetermined points, namely, points 58 and 60, in a planar area. At these points detectors, e.g., PIN detectors, can be installed to provide input signals for a dynamic control circuit 62. The output signals of the control circuit 62 are supplied to variable attenuators 68 and 70, installed in each channel, to receive light corresponding to that channel that is incident on either PBQC structure 52 or 54, and is transmitted through the respective PBQC structure onto one of the attenuators. The output signals provided by the control circuit 62 allow balancing the light power outputs 72 and 74 of the attenuators 68 and 70, respectively. It should be emphasized that the ability of the PBQC structures of the invention to focus the light beams of different wavelengths into any set of predetermined points over the planar area allows for considerable flexibility in the designing integrated optical circuits, such as the above channel monitoring and control device 48, since the beams may intersect each other when propagating within the planar waveguide.

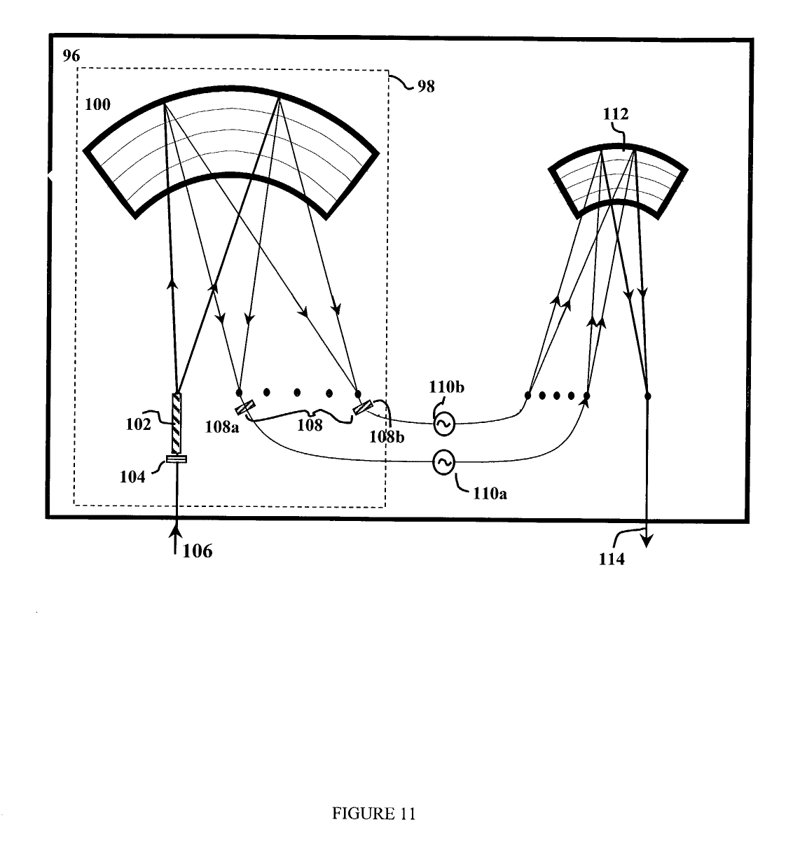

As shown in FIG. 10, the device presented in FIG. 9 can be modified by replacing the separate demultiplexer 50 and PBQC structures 52 and 54 with a single PBQC structure 76 that is designed in accordance with the teachings of the invention to reflect and focus a small portion of light corresponding to selected passband regions encompassed within wavelength components of an incoming light signal 78 to points 80 and 82 at which PIN detectors are installed, and to reflect concurrently a larger portion of each of these passband regions to respective attenuators 84 and 86. As in the device of FIG. 9, the output signals of the PIN detectors are transmitted to the control unit 62 which in turn applies control signals 88 and 90 to attenuator 86 and 84, respectively, to set the attenuation level of each attenuator to obtain desired power levels for output signals 92 and 94. Channel monitoring requires reflection of approximately 10% of the power of an incoming signal, which can be achieved by applying small coefficients αₗ for sub-gratings corresponding to the channel monitor. A flat top transfer function, desirable for a channel monitor, can be achieved by applying a chirped generating function.

Another application of PBQC structures of the invention relate to multi-wavelength lasers that can be important elements of WDM systems. While multi-wavelength lasers can be realized with Fiber Bragg Gratings, the wavelengths of such lasers should be demultiplexed before modulation. Utilization of a PBQC-based demultiplexer according to teachings of the invention as an intra-cavity selective element makes it possible to realize simultaneously multi-wavelength lasing and demultiplexing/multiplexing, which is of considerable interest for telecommunication purposes.

For example, FIG. 11 depicts an integrated transmitting part of an optical telecommunication system 96 having a multi-wavelength laser 98 in which a PBQC structure 100 according to the invention is incorporated to serve as a wavelength selective element for establishment of multiple lasing cavities for a plurality of wavelengths with a common active lasing medium 102 and a high-reflectivity broadband mirror 104 installed in the common focal point of the PBQC. A pump signal 106, for example, from another laser, pumps the lasing medium 102 in order to generate the requisite population inversion. A plurality of mirrors 108, such as mirrors 108a and 108b, each providing partial reflectivity, are positioned at the output focal points corresponding to the respective wavelength components. Thus, each mirror 106, together with the PBQC and the common lasing medium and the broadband mirror, provide a lasing cavity for a selected wavelength. Proper selection of mirror's reflectivity together with proper design of the PBQC structure make it possible to optimize the laser source performance.

Each mirror 108 allows a portion of the laser radiation corresponding to its respective wavelength to be outputted to a modulator, such as modulators 110a and 110b, that modulates the light corresponding to that wavelength. An optical multiplexer 112, formed in accordance with the teachings of the invention, combines light corresponding to different wavelength channels to provide a WDM signal 114 at the circuit output, for example, for transmitting through a single fiber.

It should be mentioned that the additional measures may have to be taken for providing stable operation of such a system [N. J. C. Libatique and D. Huang, IEEE Photon. Technol. Lett. 11, 1584 (1999)], which is possible due to the fact that different wavelength channels outputted by the laser are spatially separated, thus allowing for additional power control according to the teaching of the previous example. Spatial separation of the channels is also advantageous because it allows the signal modulators to be installed in each channel immediately after the corresponding output ports, thus eliminating the need for an additional demultiplexer as it would be required in the case of multiwavelength sources utilizing fiber Bragg gratings.

The teachings of the invention, including the approach presented above for designing the above telecommunications systems, allow for optimal design of the MUX-DEMUX configurations while taking into account different requirements that need to be fulfilled in different parts of the circuit. For example, planar lasers generate linearly polarized light. Thus, a multiplexer can be designed for only one polarization. This can be achieved by setting to zero the coefficients αᵢ in the above Equation (1) corresponding to another polarization. It should be also emphasized that the proposed approach opens ways for designing an entire transmitting part of a fiber-optic communication system integrated on a single planar optical waveguide.

In the following sections, various improvements and enhancements to the optical devices of the invention described above are presented.

Crosstalk

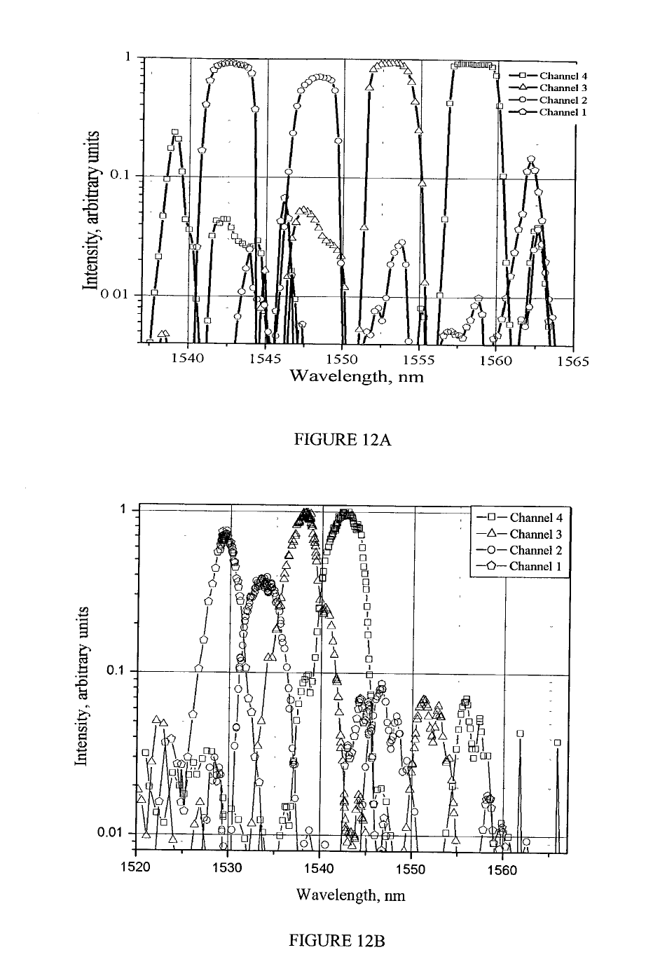

As discussed above, in many embodiments of the invention, the generating function A(x,y) is approximated by a binary representation defined by the function B(x,y). This binarization procedure is non-linear and should result in non-linear effects that can enhance cross-talk among various channels of an optical device having a multi-bandgap photonic structure formed in accordance with the teachings of the invention. An optical channel, as used herein, refers to an optical connection, i.e., transmission, between an input port of a device of the invention to one or more selected output ports for a given passband region. For example, with reference to FIG. 12A, a proto-type demultiplexer device built according to the teachings of the invention without utilizing provisions for reducing crosstalk as discussed below, exhibits a cross-talk of approximately 11 dB among its four channels, determined by simulation. FIG. 12B depicts the transfer function of the same device which is measured experimentally to exhibit the same cross-talk level, which can be unacceptably high for many applications.

In some embodiments of the invention, cross-talk among various optical channels is advantageously minimized by judicious positioning of the output ports. That is, one or more constraints on the location of each output port relative to the others is imposed to ensure that only light having wavelengths close to a central wavelength of a passband region associated with that output port is directed by the PBQC structure from the input port to that output port.

More particularly, in one embodiment, the location of an output port associated with a passband region having a central wavelength λᵢ is defined in accord with the relation:

$${\vec{R}}_{i} = {\vec{R}}_{0} + δ \vec{R} \frac{1}{{λ}_{i}} \qquad Eq . ( 7 )$$

wherein \vec{R}₀ and δ\vec{R} are arbitrary vectors which are utilized, upon selection, for determining the locations of all of the output ports in accord with Equation (7). In other words, for any two output ports located at positions \vec{R}ₗ and \vec{R}ⱼ which are associated with passband regions λₗ and λⱼ, the following relation is satisfied:

$${\vec{R}}_{i} - {\vec{R}}_{j} = δ \vec{R} ( \frac{1}{{λ}_{i}} - \frac{1}{{λ}_{j}} ) \qquad Eq . ( 8 )$$

The position of the input port is, however, arbitrary. Further, it should be understood that the above Equation can be satisfied so long as the left and the right portions are equal within ±5 percent.

Without being limited by theory, and simply for providing some understanding of the physical reasons for efficacy of utilizing Equation (8) for locating the output ports of an optical device of the invention in order to minimize crosstalk, the following explanation is provided. In particular, as mentioned above, substitution of the generating function A(x,y) by binary features, e.g., dashes, is a strongly non-linear transformation which causes the resulting binary representation to include not only the Fourier components of A(x,y) but also various beatings among these Fourier components. For example, if A(x,y) includes only three Fourier components with wave vectors, \vec{k}₁, \vec{k}₂ and \vec{k}₃, the Fourier spectrum of the generated binary relief can include beatings such as m\vec{k}₁+n\vec{k}₂+l\vec{k}₃, where m, n and l are arbitrary positive or negative integers. Such beatings can give rise to crosstalk among various channels. While each channel is associated with a packet of wave-vectors, the packet can be effectively approximated by a single wave-vector \vec{k}.

In many practical embodiments of the invention, all wave vectors of sub-gratings have substantially similar absolute values and directions. Thus, combinations such as kₗ+(\vec{k}ⱼ−\vec{k}ₖ) are close to original wave vectors and they will reflect light with approximately the same frequencies in approximately the same directions. Additional analysis indicates that the reflections are focused, thus further contributing to the crosstalk.

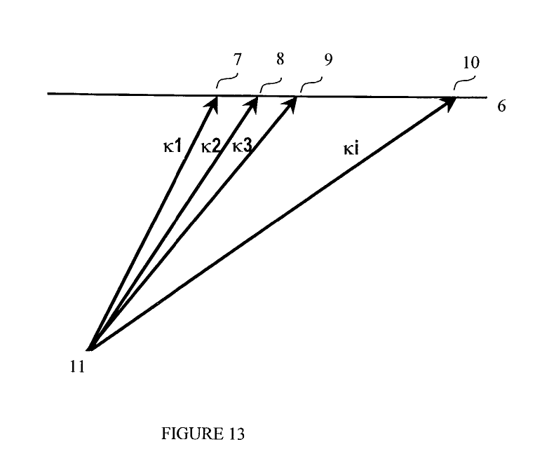

The crosstalk, however, can be substantially corrected by a proper positioning of output ports, as discussed above. Such a positioning of the output ports imposes constraints on the generating function A(x,y) such that the directions of the wave-vectors associated with a channel sub-gratings vary linearly with the absolute values of these wavevectors so that the tips of the vectors lie on a straight line, as shown in FIG. 13 for exemplary wave vectors k₁, k₂, k₃, . . . , kₗ. Hence, in the limit of small numerical aperature and small ellipticity, any linear combination of the wave-vectors lies on the same straight line. That is, the frequency of the reflected light is a function of reflection direction and, consequently, crosstalk is minimized.

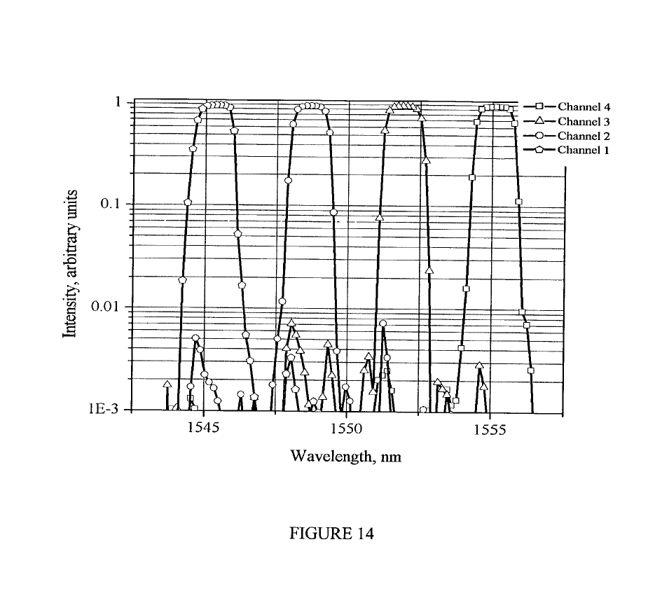

By way of example and for providing corroboration of the efficacy of the above teachings for correcting non-linearity introduced by binarization to minimize crosstalk, FIG. 14A provides simulation data for an optical device formed in accordance with the teachings of the invention having one input port and four output ports positioned in accord with Equation (8), each of which corresponds to a particular optical channel associated with a particular passband region. FIG. 14B provides experimental data for a similar optical device. Both the simulation and the experimental data indicate a level of channel isolation that is substantially higher than that obtained without the use of output port positioning. In particular, whereas the prototype device of FIG. 12A above, which does not include provisions for minimizing crosstalk, exhibits a channel isolation of about 11 dB the channel isolation depicted by FIGS. 14A and 14B are about 22 dB and 28 dB, respectively.

In another embodiment of the invention, crosstalk among various channels is substantially reduced by designing the generating function to include pre-compensation for binarization non-linearity. In particular, the generating function A(x,y) can be defined in accord with the relation:

$$\begin{matrix}A ( x , y ) = {\sum }_{i = 1}^{i = N} {a}_{i} Sin {Ψ}_{i} + P {\sum }_{i = 1}^{i = N} {\sum }_{j = 1}^{j = N} {\sum }_{k = 1}^{k = N} {a}_{i} {a}_{j} {a}_{k} \\ Sin ( {Ψ}_{i} + {Ψ}_{j} - {Ψ}_{k} + {Ψ}_{0} ) \end{matrix} \qquad Eq . ( 9 )$$

wherein

Ψₗ=2π(1+ƒ(x,y))lₗ/λₗ+Φₗ Eq. (10)

and i, j, and k are indices that refer to connections made from the input port to different selected output ports,

Similar to previously defined generating function, lₗ=|\vec{r}ₗⁱⁿ|+|\vec{r}ₗ^{out}|, wherein \vec{r}ₗⁱⁿ is a vector connecting the input port i to an arbitrary point (x,y) on the planar surface, \vec{r}ₗ^{out} is a vector that connects this point (x,y) with the output port i for a chosen wavelength λₗ, and

αₗ, αⱼ, αₖ are weight coefficients associated with the connections i, j, and k, respectively, and can be determined by experiment and/or simulation. Further, ƒ(x,y) is a function that compensates for variation of refractive index, as discussed in detail above. Further, P represents a pre-compensation coefficient which can be negative or positive, and Ψ₀ represents an arbitrary phase shift. Both P and Ψ₀ can be determined by experiment and/or simulation in order to minimize the crosstalk.

The impact of the generating function defined by Equation (9) in reducing crosstalk can be understood by considering perturbation theory. In particular, when the number of channels in an optical device of the invention is large, the contribution of each channel to the generating function, and the binarization non-linearity, are small. Hence, subtracting the most pronounced perturbations from an original generating function, e.g., the first term in Equation (9), can lead, in linear approximation, to suppressing these perturbations, and their associated effects on crosstalk.

Dispersion Correction

An optical device can modify an amplitude and/or a phase of an input optical signal to generate an output signal. In other words, a transfer function of an optical device is characterized not only by amplitude change but also by phase shifts. A phase shift and/or a first derivative of the phase with respect to frequency may cause signal degradation. For example, the first derivative of a signal phase with respect to frequency can lead to signal delay and not signal distortion. A second derivative of the signal phase with respect to frequency is known as dispersion and a third derivative of the signal phase with respect to frequency is known as dispersion slope. Dispersion and dispersion slope, however, can significantly limit performance of optical transmission systems, and hence should be minimized.

PBQC structures of the invention are flexible devices that are characterized by a large number, e.g., thousands, of fitting parameters that can be adjusted to compensate for dispersion and dispersion slope introduced by the PBQC structures themselves, as well as those introduced by optical fibers and other devices coupled to these structures. Dispersion in a PBQC structure of the invention can originate from motion of the effective reflection point of light in the structure as function of light frequency. Hence, in some embodiments, dispersion can be compensated by moving the effective reflection point through variation of the period of sub-gratings, referred to as chirp, in the generating function. For example, in one embodiment, a linear chirp is introduced to replace the optical path length lₗ with lᵢ(1+h_{λi}^{li}) in the above Equation (1). The chirp coefficient h can be adjusted to compensate for positive or negative dispersion. In particular, such compensations can be made proportional to the chirp coefficient h. A typical value for the chirp coefficient h is about 10⁻⁶.

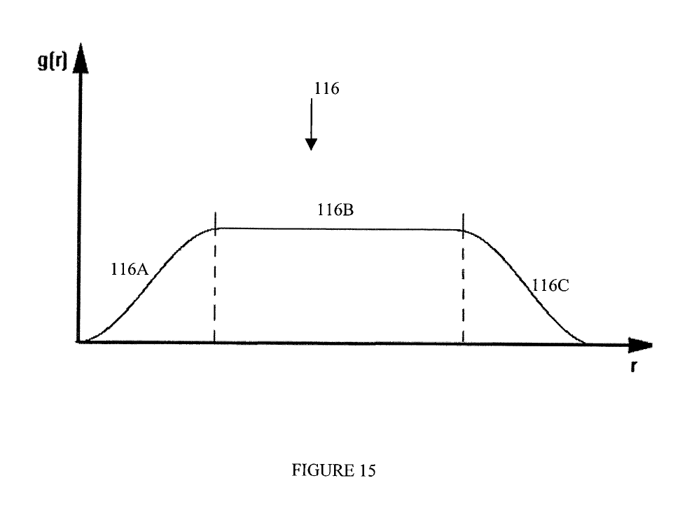

In addition to providing the ability to compensate for dispersion, chirped sub-gratings of a PBQC structure of the invention as described above can provide additional advantages. For example, they can enhance flatness of the associated transfer function, especially if a function utilized to apodize the sub-gratings includes a flat central portion. By way of example, FIG. 15 illustrates such an apodization function 116 that corresponds to zero variation of refraction index everywhere but the PBQC area. Within the PBQC area, the exemplary apodization function 116 includes the following three zones: zone 116A that is characterized by an increase in modulation, zone 116B that is substantially flat and corresponds to maximum modulation, and zone 116C that is characterized by a decrease in modulation from the maximum value in zone 116B to vanishing values.

In some embodiments of the invention, compensation of a dispersion slope associated with a PBQC structure of the invention can be accomplished by splitting each sub-grating corresponding to a central frequency ωₗ (1/λₗ) to two sub-gratings corresponding to two frequencies symmetrically disposed about the frequency ωₗ. For example, a term sin ψₗ in the generating function A(x,y) corresponding to frequency ωᵢ can be replaced with a summation of two terms sin ψₗ¹ and sin ψₗ², corresponding to frequencies (ωₗ+Δ) and (ωₗ−Δ) respectively. In other words, the generating function A(x,y) can be defined in accord with the following relation:

$$A ( x , y ) ∼ {\sum }_{i = 1}^{i = N} [ {a}_{i}^{1} sin ( 2 π ( 1 + f ( x , y ) ) {l}_{i} ( \frac{1}{{λ}_{i}} + Δ ) + {φ}_{i}^{1} ) + \\ {a}_{i}^{2} sin ( 2 π ( 1 + f ( x , y ) ) {l}_{i} ( \frac{1}{{λ}_{i}} - Δ ) + {φ}_{i}^{2} ) ] \qquad Eq . ( 11 )$$

wherein αₗ¹ and αₗ² are weight coefficients corresponding to frequencies (ωₗ+Δ) and (ωₗ−Δ), respectively. The other various parameters of A(x,y) are defined as previously described in the above Equation (1), and can be found through experiment and/or simulation.

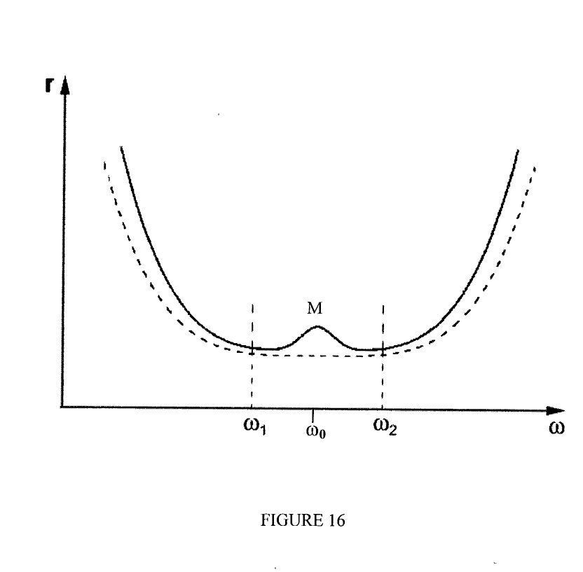

The dispersion slope is proportional to the second derivative of the distance of the effective reflection point within a PBQC structure relative to the front edge of the structure, i.e., the edge facing the incoming light, with respect to light frequency. FIG. 16 schematically depicts motion of the effective reflection point (solid line) corresponding to reflection from two sub-gratings associated with frequencies ω₁ and ω₂, symmetrically disposed about a frequency ω₀. As the frequency increases towards ω₁, the reflection distance decreases to reach a minimum at ω₁. Upon increasing the frequency beyond ω₁, the reflection distance increases to reach a local maximum at point M, and then decreases to reach another local minimum at ω₂, and subsequently begins to increase. It is evident that the second and third derivatives are zero at point M (see dashed line). Thus, the dispersion slope as well as the next order dispersion are compensated. The parameters in the above Equation (11) that result in such behavior of the reflection distance can be obtained, for example, by iteration. For example, parameters αₗ¹ and αₗ² can be selected to be equal and constant, then the splitting frequency Δ can be increased until the simulated dispersion slope is zero. The symmetry of the curve on FIG. 16 indicates that the next order dispersion is equal to zero automatically.

Bandwidth Utilization

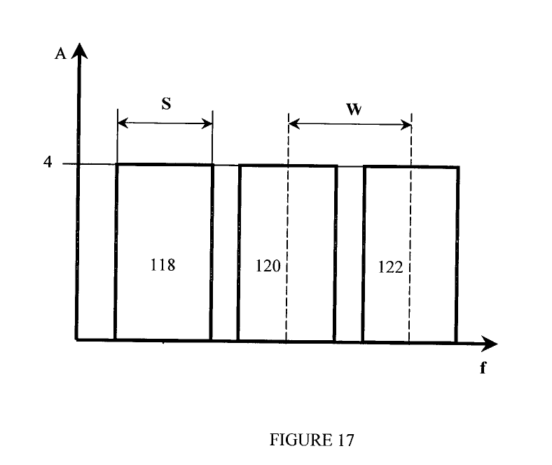

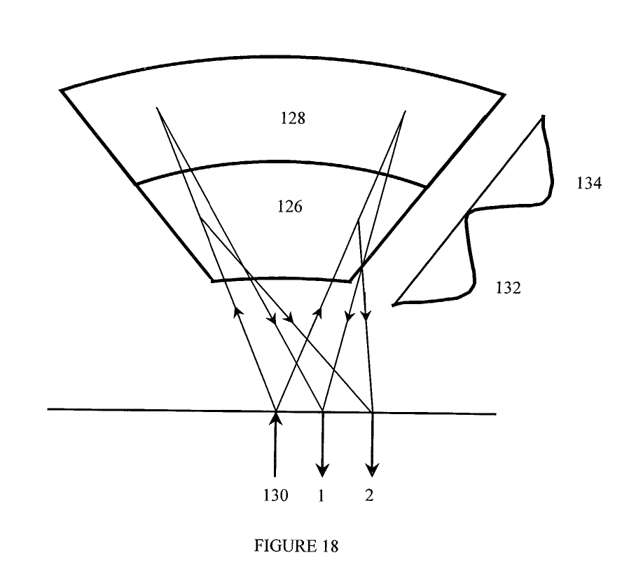

In many WDM applications, it is desirable to efficiently utilize an available bandwidth by maximizing the bandwidth of each passband region associated with an optical channel relative to the spacing with the neighboring channels. That is, it is desirable to distribute different passband regions associated with different optical channels within a selected wavelength range, which corresponds to an available bandwidth, such that the spacings among the passband regions are minimized. For example, in FIG. 17, three passband regions 118, 120, and 122 are depicted, each of which has a bandwidth W. Further, a parameter S denotes a measure of the spacing between two neighboring passband regions. It is desirable to maximize the ratio (W/S).

While the ratio (W/S) in some commercial WDM systems is currently less than about 0.1, there is a desire to increase this ratio to a value as high as 0.5. The proximity of the different channels to one another in the frequency space can, however, lead to strong channel interactions, and consequently to undesirable crosstalk. Even if wave equations can be considered linear with high accuracy, solutions do depend non-linearly on coefficients in these equations.

In particular, in optical devices of the invention as described above, photonic bandgaps associated with different channels cannot be considered as independent for tight channel spacing. However, because of the resonant nature of light scattering, a channel is primarily affected by its two neighboring channels, one having a higher center frequency and the other a lower center frequency. To avoid interactions of each optical channel with its nearest neighboring channels, some embodiments utilize a photonic bandgap structure, or PBQC, according to the teachings of the invention that includes at least two portions, one of which directs light to a first set of output ports and the other directs light to a second set of output ports such that each port in the first set is associated with a passband region that is adjacent in frequency space to one or more passband regions associated with one or more output ports in the second set, and vice versa. In other words, if the channels (and/or output ports associated with the channels) by an increasing progression of integers correlated with increase in central channel frequencies, then one portion of the PBQC directs light corresponding to odd channels (directs light to odd output ports) and the other portion directs light corresponding to even channels (directs light to even output ports).

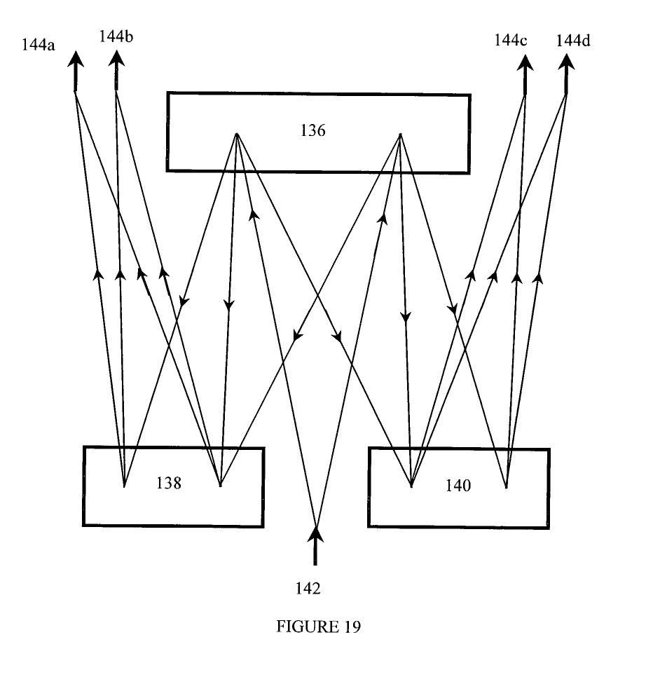

For example, FIG. 18 schematically depicts a PBQC structure 124 according to the teachings of the invention having a first portion 126 and a second portion 128. The portion 126 includes a plurality of sub-gratings defined by a binary approximation of a generating function of the invention such that light corresponding to the even channels is directed to selected ports, such as, port 2, and light corresponding to the odd channels is transmitted to the portion 128. The portion 128 in turn includes sub-gratings according to the teachings of the invention to direct light corresponding to the odd channels to selected ports, such as, port 1. By way of additional example, for an input light 130 having passband regions 118 and 120 depicted in FIG. 17, the portion 126 and 128 can be designed such that the portion 126 directs the passband region 118 to the port 1, and the portion 128 directs the passband region 120 to the port 2. This separation of the PBQC in two portions advantageously minimizes interactions among neighboring channels, and hence ameliorates crosstalk among these channels.

The PBQC structure 124 can be manufactured by utilizing two generating functions A₁(x,y) and A₂(x,y), each of which represents a pattern of refractive index modulation corresponding to one of the portions 126 and 128. For example, a relief structure of micro-reflective elements in the portion 126 can be generated based on a binary representation of A₁(x,y) whose parameters are selected, e.g., by experiment or simulation, so as to reflect light in first selected passband regions from an input port to the odd output ports. Further, the portion 128 can be formed of a plurality of micro-reflective elements based on a binary representation of A₂(x,y) whose parameters are selected so as to reflect light in second selected passband regions, interleaved relative to the first passband regions, from the input port to the even output ports.

As shown schematically in FIG. 18, each portion 126 and 128 is preferably apodized separately. For example, an apodizing function, such as an exemplary function schematically depicted by a curve 132, can be employed to apodize the portion 126. The exemplary function 132 reaches a maximum value at the center of the portion 126, and decays on both sides of the maximum to vanishing values at a front edge 124a of the PBQC structure and at a boundary between the portions 126 and 128. A similar function, schematically depicted by a curve 134, can be employed to independently apodize the portion 128.

Cascading

In some embodiments of the invention, crosstalk among various optical channels is suppressed by cascading two or more PBQC's of the invention each of which is preferably characterized by a flat top transfer function, as described in more detail below.

For example, FIG. 19 schematically illustrates two pairs of cascaded PBQC structures, one of which is formed by PBQC structures 136 and 138, and the other by PBQC structures 136 and 140. The PBQC structures can be formed on a single planar waveguide by utilizing the methods of the invention described in detail above. In this exemplary embodiment, the PBQC structures 136, 138, and 140 provide four optical channels, each corresponding to a selected passband region, between an input port 142 and four output port 144a, 144b, 144c, and 144d. Those having ordinary skill in the art will appreciate that although four channels are presented here for illustrative purposes, any number of channels can be utilized.

More particularly, in this exemplary embodiment, the PBQC structures 136 and 138 cooperatively direct light corresponding to two passband regions in a first set, which are separated by an intervening passband region in a second set, from the input port 142 to respective output ports 144a and 144c (e.g., odd output ports), whereas the PBQC structures 136 and 140 cooperatively direct light corresponding to two passband regions in the second set from the input port 142 to respective output ports 144b and 144d (e.g., even ports). The designation of odd and even for the output ports was described above, and hence is not repeated here. Accordingly, for any two adjacent frequency channels, the PBQC structure 138 provides reflection and focusing onto the output ports for one channel and the PBQC 140 provides reflection and focusing for the other channel.

The generating function associated with a pair of cascaded PBQC structures can have the general form provided by the above Equation (1) for the generating function A(x,y). However, the positions of the output ports of a first PBQC structure in a cascaded pair should coincide with corresponding input channels of the second structure in the pair. For example, the optical path lengths for the generating function of a first member of a cascaded pair can be defined in accord with the relation:

lₗ_{₁}=|\vec{r}ₗⁱⁿ|+|\vec{r}ₗ^{int}| Eq. (12)

wherein lₗ_{₁} represents an optical path length corresponding to the i^{th} connection in the first PBQC structure, \vec{r}ₗⁱⁿ is a vector connecting an input port to an arbitrary point (x,y) in the first PBQC structure, and \vec{r}ₗ^{int} is a vector connecting the point (x,y) to an intermediate virtual port. The intermediate port is referred to as a virtual port because it is not a physical port of the device, but rather a location at which the light reflected from the first PBQC would focus. However, the light reflected from the first PBQC may not reach the intermediate virtual point because it may be intercepted by the second member of the pair.

In embodiments in which the intermediate virtual port lies at a location such that the light reflected from the first PBQC structure is incident on the second PBQC structure as a converging beam (for example, when the second member intercepts light reflected from the first member before reaching the intermediate port, e.g., virtual port lies outside the waveguide), the optical path length lₗ_{₂} utilized in a generating function A(x,y) associated with the second PBQC structure can be defined in accord with the relation:

lₗ_{₂}=|\vec{r}ₗ^{out}|−|\vec{r}ₗ^{int}| Eq. (13)

wherein \vec{r}ₗ^{out} represents a vector extending from an arbitrary point (x,y) within the second PBQC structure to an output port associated with the i^{th} connection. That is, each sub-grating defined by the generating function associated with the second PBQC structure is formed as a plurality of hyperbolic, rather than elliptical, grating lines.

In other embodiments, the sub-gratings of the first PBQC structure of a cascaded pair are formed as a plurality of hyperbolic grating lines, and the sub-gratings of the second PBQC structure are formed as a plurality of elliptical grating lines. That is, the light reflected by the first PBQC structure is intercepted by the second PBQC structure as a divergent beam. In other words, the optical path lengths utilized in the generating functions of the first and second PBQC structures, lₗ_{₁} and lₗ_{₂}, respectively, are defined in accord with the following relation:

lₗ_{₁}=|\vec{r}ₗⁱⁿ|−|\vec{r}ᵢ^{int}|

lₗ_{₂}=|\vec{r}ₗ^{out}|+|\vec{r}ᵢ^{int}| Eq. (14)

wherein the various parameters are defined as in the above equations (12) and (13).

In some other embodiments in which the intermediate ports are placed between the first and the second members of the cascaded pair, the sub-gratings of the first and second PBQC structures are elliptical. In other words, the optical path lengths lₗ_{₁} and lₗ_{₂} are defined in accord with the following equations:

lₗ_{₁}=|\vec{r}ₗⁱⁿ|+|\vec{r}ₗ^{int}|

lₗ_{₂}=|\vec{r}ₗ^{out}|+|\vec{r}ₗ^{int}| Eq. (15)

In some other embodiments of the invention, the output ports associated with a first member of a cascaded pair (the intermediate ports) are placed at infinity so that the first member directs parallel beams to the second member. In such embodiments, the optical path length utilized in the generating function associated with the first member is defined in accord with the following relation:

lₗ_{₁}=|\vec{r}ₗⁱⁿ|+(\vec{r}·\vec{n}ₗ) Eq. (16)

wherein \vec{n}ₗ represents a unit vector in the direction of corresponding parallel beams. The sub-gratings defined by utilizing the above equation (16) in the generating function of Equation (1) above are parabolic rather than elliptical.

Analogously, in the optical path length in the generating function of the second PBQC structure of the cascaded pair is defined in accord with the following relation:

lₗ_{₂}=|\vec{r}ᵢ^{out}|−(\vec{r}·\vec{n}ᵢ) Eq. (17)

The combined transfer function of a pair of cascaded PBQC's can be represented as a product of the transfer functions of each PBQC structure of the pair. For example, if the transfer function of the first structure is represented as t₁(ω) and that of the second structure is represented by t₂(ω), the combined transfer function of the cascaded pair is t₁(ω)·t₂(ω). In many embodiments, the transfer functions of the PBQC structures of the cascade are selected to have flat top profiles so that the multiplication of the transfer functions in the cascade will result in a substantial decrease in crosstalk level. For example, if the crosstalk associated with each individual member is −15 db, the multiplication of the transfer functions can result in a crosstalk of −30 db for the cascaded pair.

Further, associating odd and even channels to different PBQC's in a set of cascaded PBQC structures, as shown in exemplary embodiment of FIG. 19, can further reduce crosstalk among various optical channels.

Moreover, employing cascading in an optical device of the invention enhances the flexibility of the device. For example, as discussed above, a linear chirp can be employed in the generating function to obtain a flat top transfer function. Such a linear chirp can create positive or negative dispersion. Applying a positive chirp in one member of a cascaded pair and a compensating (e.g., equal) but negative one in the other member can result in zero total dispersion.

Adjustment of Channel Bandwidth

A photonic multi-bandgap structure of the invention can be designed such that each passband region, corresponding to an optical channel, that is directed by the structure from an input port to a pre-selected output port(s) has a selected bandwidth. This bandwidth can be the same or different from the bandwidths of the other channels. In particular, there exits a linear relationship between the bandwidth of a particular channel (i) associated with a wavelength λₗ (frequency ƒₗ) and the weight coefficient αₗ corresponding to the sub-grating associated with that wavelength (frequency) in the definition of the generating function A(x,y) provided in the above Equation (1). In other words, the channel bandwith (Δƒₗ) is related to the weight coefficient αₗ in accord with the relation:

Δƒₗ=καₗ Eq. (18),

wherein κ is a proportionality constant.

Accordingly, in some embodiments of the invention, the bandwidth of an optical channel, e.g., channel associated with wavelength λₗ, can be adjusted by varying its associated weight, e.g., αₗ. In this manner, different bandwidths for different optical channels can be generated in the same optical device of the invention. For example, one bandwidth can be designed to be 100 GHz while another can be designed to be 400 GHz (these exemplary bandwidths are both standard ITU grids).

In other embodiments, channels of arbitrary bandwidths are obtained by chirping the terms corresponding to various sub-gratings in the generating function A(x,y). Application of chirp to various sub-gratings was described above, and hence is not repeated here. The width of an optical channel is proportional to the applied chirp, i.e., the chirp coefficient h. Thus, by employing different chirp coefficients for different sub-gratings, a number of different channel bandwidths can be obtained. In other words, an optical path length associated with a sub-grating corresponding to a wavelength λᵢ can be defined as lᵢ(1+hᵢ_{_{λi}}^{li}), wherein hₗ is a chirp coefficient. The chirp coefficient hₗ can be different for different wavelengths (frequencies).

Compensation of PDL with Birefringence

In a planar optical device, polarization dependent loss (PDL) can originates primarily from a difference in the effective refraction indices of TE and TM modes. In optical device of the invention, there are two sources that can cause differences in the effective refraction indices of the TE and TM modes. In particular, a first source is the planar geometry of the waveguide, which can cause such a difference. It is known that in a planar isotropic medium, the effective refraction index of a TE mode is always higher than that of a TM mode.

The second source is birefringence, which can originate from the mechanical stress created by differences in the thermal expansion coefficients of core, cladding, and base materials. This stress can depend on manufacturing history and operating temperature of the planar waveguide structure. This stress-induced birefringence can be positive or negative.

Applicants have discovered that differences in the refractive indices of the TE and TM modes caused by birefringence and geometry can be adjusted so as to substantially reduce the difference originating from one source with a compensating difference originating from the other source, especially when the scale of variation is sufficiently large.

In silica on silicon wafers, the base silicon is typically much thicker that the silica layer, and hence determines characteristics associated with thermal contraction. In silica on silicon wafers, the birefringence-induced difference in the effective refraction indices is typically negative and has a value close to −0.0005. The difference originating from planar geometry is, however, positive.

In some embodiments, the difference in the refractive indices of the TE and TM modes in the planar waveguide is regulated by a judicious selection of the core thickness and/or by ensuring that a difference between the refractive indices of the core and the cladding lies in a selected range.

Simulations performed by Applicants have demonstrated that a positive shift of 0.0005, suitable for birefringence compensation, can be achieved with a core thickness in a range between 3 microns and 6 microns. For example, for the mentioned silica-on-silicon planar waveguide, the refractive index of the core may be about 1.470 while the cladding refractive index may be about 1.445. Further, fine-tuning of the birefringence compensation can be achieved by temperature variations which can modify mechanical stress in the waveguide, and consequently the degree of birefringence.

Planar Design

Planar waveguides usually support several types of wave modes, such as TE and TM modes, and core and cladding modes. In some embodiments of the invention, the planar waveguide is designed to provide large frequency gaps between the modes, thereby placing parasitic resonance between different modes beyond the working bandwidth.

For example, as discussed above in detail, in one embodiment, the following relationship is observed:

$$\frac{{γ}_{E} - {γ}_{M}}{{γ}_{E}} > 2 \frac{Δ ω}{ω} \qquad Eq . ( 19 )$$

wherein γ_{E} represents the effective index of refraction for the TE mode, γ_{M} represents the effective index of refraction for the TM mode, and Δω is the working spectral range of the WDM system centered around frequency ω. If mutual transformation of TE and TM modes can be neglected, the above condition may be relaxed as follows:

$$\frac{{γ}_{E} - {γ}_{M}}{{γ}_{E}} > \frac{Δ ω}{ω} . \qquad Eq . ( 20 )$$

As discussed above, this allows for writing separate sub-gratings for TE and TM polarizations. Different reflection coefficients for TE and TM polarizations can be compensated by varying coefficients αᵢ associated with the sub-gratings (Eq. (1)).

To avoid resonance with cladding modes, conditions analogous to those described above should be imposed, but the effective refraction coefficient for the TM mode should be substituted by the effective refraction coefficient of a cladding mode.

In some embodiments, the refraction indices of different layers forming a planar waveguide are selected to be sufficiently different so as to obtain large frequency gaps between various modes. Further, the thickness of the core is preferably chosen to prevent appearance of a second core mode with the same polarization (the thickness is not too large). By way of example, simulated transfer functions shown in FIG. 12A and the experimentally measured transfer function of FIG. 12B were obtained for a planar design according to the teachings of the invention having a core thickness of about 0.4 microns, a core refraction index (RI) of 1.75 and a cladding refraction index of 1.44. In this planar design, the effective refraction index of the TE mode is about 1.53, and that of the TM mode is about 1.47. Further, the effective index of refraction associated with the cladding mode is about 1.44.

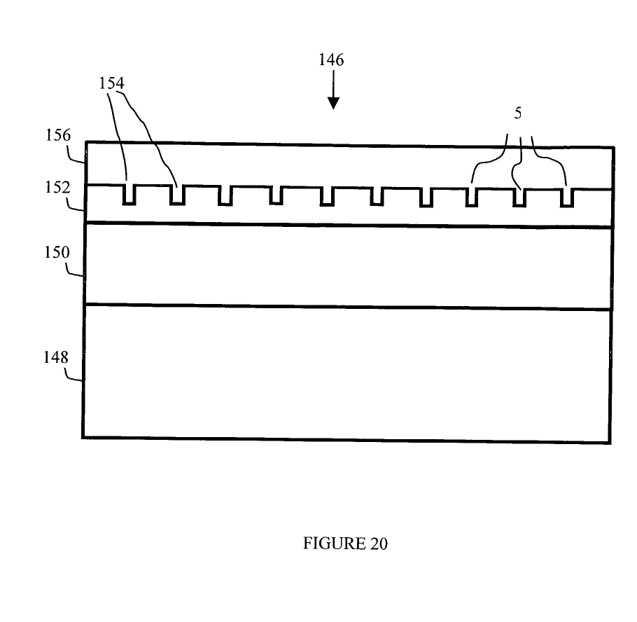

FIG. 20 illustrates an exemplary optical device 146 of the invention having a planar waveguide that includes a base plate 148 formed of silicon, a buffer layer (lower cladding) 150 formed by thermal oxidation of the silicon base plate, and a core layer 152 formed over the cladding layer. A PBQC structure 154 according to the teachings of the invention can be etched, for example, on a top surface of the core layer 152, as shown in FIG. 20. Alternatively, the PBQC structure can be etched on top of the lower cladding layer. Subsequent to patterning the PBQC structure, additional layers, such as an upper cladding layer 156, can be deposited over the core layer.

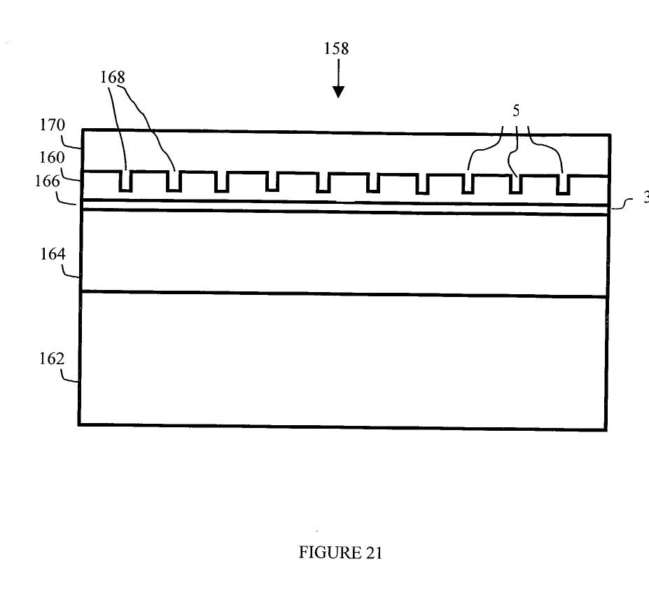

In some embodiments, PBQC structures of the invention are formed on semiconductor wafers having semiconductor core layers for integration with active devices, such as, lasers, amplifiers, modulator, etc. Semiconductors typically exhibit large refraction indices. For example, silicon and InP have refraction indices of 3.48 and 3.2, respectively. For example, FIG. 21 illustrates an exemplary planar optical device 158 according to the teachings of the invention having a planar waveguide that includes a semiconductor core 166. In addition to a base 162 and lower cladding layer 164, the device 158 further includes an intermediate cladding layer 160. The refractive index of the intermediate layer is preferably greater than that of the upper cladding layer and lower than that of the core layer. For example, for the core/cladding refractive indices 3.48/1.44, respectively, the refractive index of the intermediate layer can vary between about 1.5 and 1.75. The intermediate layer can decrease the asymmetry of the TE and TM modes, and can adjust the reflectivity of the micro-reflectors to an optimal level by smoothing the transverse refractive index profile. A PBQC structure according to the teachings of the invention is etched on the surface of the core layer 160 that is covered with an upper cladding layer 170 having a refractive index lower than that of the intermediate cladding layer 166.

Scattering Suppression

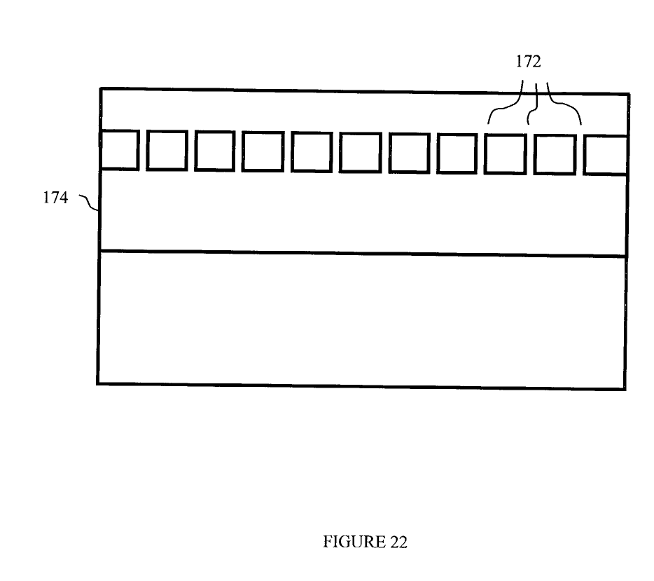

In an optical device that utilizes a planar waveguide for light transmission, scattering of light into modes that are not confined by the planar waveguide, herein referred to as radiating modes (the modes confined by the waveguide are herein referred to as core modes), can cause optical loss. In some embodiments of the invention, such an optical loss can be substantially reduced by generating refractive index variations in the core of the waveguide rather than at core-cladding interface. In particular, with reference to FIG. 22, a plurality of micro-reflective elements 172 can be generated according to the teachings of the invention on a surface within a 174 core of a waveguide, for example, at locations proximate to maximum intensity of the electromagnetic wave traveling through the waveguide. Such positioning of the micro-reflective elements advantageously minimizes coupling to radiating modes, thereby lowering optical loss.

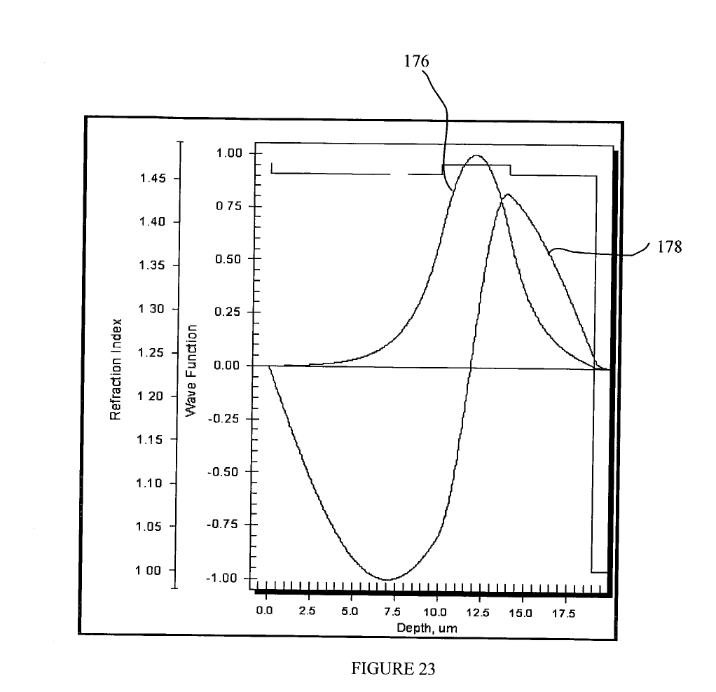

The coefficients for coupling to radiating modes, in some approximation, are proportional to intensities of radiating waves at the gratings. FIG. 23 represents simulated core mode 176 and cladding radiating mode 178. The intensity of the cladding radiating mode reaches zero at the center of the core layer. It is clearly seen that a ratio of the intensity of the cladding radiating mode relative to that of the core mode is small at the center of the core and large at core-cladding interface. As the degree of scattering into the radiating mode is proportional to a square of this ratio, suppression of coupling into the radiating mode can be achieved by placing the gratings into portions of the core layer at which this ratio of radiating mode intensity to core mode intensity is small, for example, less than about 0.1, e.g., center of the core layer. Such positing of the gratings can advantageously result in lowering scattering loss by a factor of 10 or more. For example, in prototype devices made by Applicants in which the gratings were formed on a top surface of the core, a scattering loss in a range of about 1% to about 5% was observed. Additional suppression of the scattering loss by utilizing the above teachings can result in a scattering loss in a range of about 0.1% to about 0.5%.

In another embodiment, the spacing between micro-reflective elements forming a photonic multi-bandgap structure of the invention are selected to be approximately half of the wavelength of a mode which travels through the waveguide and couples to the photonic structure. If the spacings are exactly half of the wavelength of a core mode, the decay conditions for radiating modes are not satisfied and hence scattering of light into these modes is suppressed. In a PBQC, the spacing can vary slightly from an exact half wavelength value. Such variations result in some scattering into the radiating modes, although the scattering amplitude is small so long as the variations are small. The variations are typically small in optical devices of the invention utilized for optical communication because the bandwidth employed for optical communication is normally about 2% of the central frequency of an optical channel. This leads to a generating function A(x,y) that is almost periodical, and hence leads to an almost periodical quasi-crystal.

In some other embodiments of the inventions, scattering into radiating modes is suppressed by selecting the etching depth of each micro-reflective element, formed, for example, by etching a surface via an electron beam, to be substantially equal to half-wavelength of the electromagnetic wave traveling through the waveguide.

Those having ordinary skill in the art will appreciate that various modifications can be made to above embodiments without departing from the scope of the invention. The teachings of the various articles and other sources referenced herein are hereby incorporated by reference.

What is claimed is:

1. An optical device, comprising
an optical waveguide adapted for transmission of light having a plurality of passband regions within a selected frequency range, each passband region (i) being characterized by a central frequency ωᵢ and a frequency span Δωₗ,
at least one input port and a plurality of output ports formed in said waveguide, each output port being associated with one of the passband regions such that a location (\vec{R}ₗ) of an output port associated with passband region Δωₗ and a location (\vec{R}ⱼ) of an output port associated with another passband region Δωⱼ are substantially as follows:
\vec{R}ₗ−\vec{R}ⱼ=δ\vec{R}(ωₗ−ωⱼ)
and
a photonic multi-bandgap structure optically formed in said waveguide to direct light having frequency components within each passband region from the input port to the output port associated with that passband region.

2. An optical device, comprising
an optical waveguide having at least one input port and a plurality of output ports, the waveguide being adapted for transmission of light having one or more passband regions within a selected wavelength range between the input and output ports,
a photonic multi-bandgap structure optically formed in said waveguide as a plurality of micro-reflective elements disposed on a surface (x,y) of said waveguide at locations corresponding substantially to local maxima of a two-dimensional generating function A(x,y) representing a two-dimensional profile of refraction index and defined in accord with the relation:
$$\begin{matrix}A ( x , y ) = {\sum }_{i = 1}^{i = N} {a}_{i} Sin {Ψ}_{i} + P {\sum }_{i = 1}^{i = N} {\sum }_{j = 1}^{j = N} {\sum }_{k = 1}^{k = N} {a}_{i} {a}_{j} {a}_{k} \\ Sin ( {Ψ}_{i} + {Ψ}_{j} - {Ψ}_{k} + {Ψ}_{0} ) \end{matrix}$$
wherein
Ψₗ=2π(1+ƒ(x, y))lₗ/λₗ+Φₗ
i, j, and k are indices that refer to different optical connections made from the input port to different selected output ports,
lₗ=|\vec{r}ₗⁱⁿ|+|\vec{r}ₗ^{out}|, wherein \vec{r}ₗⁱⁿ is a vector connecting the input port i to an arbitrary point (x,y) on the planar surface, \vec{r}ₗ^{out} is a vector that connects this point (x,y) with the output port i for a chosen wavelength λₗ,
αₗ, αⱼ, αₖ are weight coefficients associated with the connections i, j, and k, respectively,
ƒ(x,y) is a function that compensates for variation of refractive index,
P represents a pre-compensation coefficient, and
Ψ₀ represents an arbitrary phase shift,
wherein, for each passband region, the photonic structure directs light from said input port to selected one or more of the output ports to form a plurality of optical channels between the input port and the output ports.

3. The optical device of claim 2, wherein the parameter P is selected so as to minimize crosstalk between any two of said optical channels.

4. An optical device, comprising
an optical waveguide having at least one input port and a plurality of output ports, the waveguide being adapted for transmission of light having one or more passband regions within a selected wavelength range between the input and output ports,
a photonic multi-bandgap structure optically formed in said waveguide as a plurality of micro-reflective elements disposed in a planar region of said waveguide at locations corresponding substantially to local maxima of a two-dimensional generating function A(x,y) representing a two-dimensional profile of refraction index as a linear superposition of a plurality of chirped sub-gratings,
wherein for each passband region within said selected wavelength, the photonic structure directs light having wavelength components with said passband region from said input port to pre-selected output port.

5. The optical device of claim 4, wherein the generating function A(x,y) is defined in accord with the relation:
$$A ( x , y ) ∼ {\sum }_{i = 1}^{i = N} {a}_{i} sin ( 2 π ( 1 + f ( x , y ) ) {l}_{i} ( 1 + h \frac{{l}_{i}}{{λ}_{i}} ) + {φ}_{i} )$$
wherein
the index i refers to a connection made between a selected input port and a selected output port, lₗ=|\vec{r}ₗⁱⁿ|+|\vec{r}ₗ^{out}|, wherein \vec{r}ₗⁱⁿ is a vector connecting the input port i to an arbitrary point (x,y) on the planar surface, \vec{r}ₗ^{out} is a vector that connects this point (x,y) with the output port i for a chosen wavelength λₗ,
αₗ is a weight coefficient associated with the connection i,
Φₗ is an arbitrary phase associated with the connection i,
ƒ(x,y) is a function that compensates for variation of refractive index, and
h is chirp coefficient.

6. The optical device of claim 5, wherein the chirp coefficient h is selected to compensate for positive and negative dispersion.

7. The optical device of claim 6, wherein the chirp coefficient h has a value of approximately 10⁻⁶.

8. An optical device, comprising
an optical waveguide having at least one input port and a plurality of output ports, the waveguide being adapted for transmission of light having one or more passband regions within a selected wavelength range between the input and output ports,
a photonic multi-bandgap structure optically formed in said waveguide as a plurality of micro-reflective elements disposed in a planar region of said waveguide at locations corresponding substantially to local maxima of a two-dimensional generating function A(x,y) representing a two-dimensional profile of refraction index as a linear superposition of a plurality of pairs of sub-gratings, each pair having first and second sub-gratings associated with first and second wavelengths, respectively, said first and second wavelengths being symmetrically disposed about a selected wavelength,
wherein for each passband region within said selected wavelength, the photonic structure directs light having wavelength components with said passband region from said input port to pre-selected output port.

9. The optical device of claim 8, wherein the generating function A(x,y) is defined in accord with the relation:
$$A ( x , y ) ∼ {\sum }_{i = 1}^{i = N} [ {a}_{i}^{1} sin ( 2 π ( 1 + f ( x , y ) ) {l}_{i} ( \frac{1}{{λ}_{i}} + Δ ) + {φ}_{i}^{1} ) + \\ {a}_{i}^{2} sin ( 2 π ( 1 + f ( x , y ) ) {l}_{i} ( \frac{1}{{λ}_{i}} - Δ ) + {φ}_{i}^{2} ) ]$$
wherein the index i refers to a connection made between a selected input port and a selected output port, lₗ=|\vec{r}ₗⁱⁿ|+|\vec{r}ₗ^{out}|, wherein \vec{r}ₗⁱⁿ is a vector connecting the input port i to an arbitrary point (x,y) on the planar surface,
\vec{r}ₗ^{out} is a vector that connects this point (x,y) with the output port i for a chosen frequency
$$\frac{1}{{λ}_{i}} ,$$
αₗ¹ and αₗ² are weight coefficients associated with two members of a pair of sub-gratings corresponding to the frequency
$$\frac{1}{{λ}_{i}} ,$$
Φₗ is an arbitrary phase associated with the connection i,
ƒ(x,y) is a function that compensates for variation of refractive index, and
Δ is a parameter indicating separation of a frequency associated with each member of the pair from the frequency
$$\frac{1}{{λ}_{i}} .$$

10. The optical device of claim 9, wherein the weight coefficients αₗ¹ and αₗ² and the parameter Δ are selected such that a second derivative of effective reflection distance of light within said photonic band gap structure with respect to frequency at frequency
$$\frac{1}{{λ}_{i}}$$
substantially vanishes.

11. An optical device, comprising
an optical waveguide having at least one input port and a plurality of output ports, the waveguide being adapted for transmitting light having a plurality of passband regions within a selected wavelength range from the input port to the output ports, said passband regions being divided into first and second sets, and
a photonic multi-bandgap structure optically formed in said waveguide, the photonic structure having first and second portions such that, for each passband region in the first set, the first portion directs light having wavelength components within said passband region from the input port to a pre-selected one of said output port and, for each passband region in the second set, the second portion directs light having wavelength components within said passband region from the input port to another pre-selected one of said output ports.

12. The optical device of claim 11, wherein each passband region in the first set is adjacent to a passband region in the second set.

13. The optical device of claim 12, wherein the passband regions in the first set are identified by an increasing progression of odd integers and the passband regions in the second set are identified by an increasing progression of even integers.

14. The optical device of claim 11, wherein the first and the second portions are independently apodized.

15. The optical device of claim 11, wherein the first portion comprises a plurality of discrete reflective micro-elements disposed on a planar surface of said waveguide at locations corresponding substantially to local maxima of a first two-dimensional generating function A₁(x,y) and the second portion comprises a plurality of discrete reflective micro-elements disposed on the planar surface at locations corresponding substantially to local maxima of a second two-dimensional generating function A₂(x,y).

16. The optical device of claim 13, wherein the first generating function provides optical connections between the input port and selected outport port corresponding to odd passband regions and the second generating function provides optical connections between the input port and other selected output ports corresponding to even passband regions.

17. An optical device, comprising
An optical waveguide having at least one input port and a plurality of output ports, the waveguide being adapted for transmission of light having one or more passband regions within a selected wavelength range between said input and output ports,
a pair of first and second photonic multi-band gap structures optically formed in said waveguide as a plurality of micro-reflective elements, for each passband region, the pair of structures cooperatively directing light having wavelength components within said passband region from the input port to pre-selected output ports,
wherein the first structure receives light from the input port and reflects the received light to the second structure, and the second structure reflects the light to a pre-selected output port.

18. The optical device of claim 17, wherein the micro-reflective elements associated with the first structure are located on a planar surface (x,y) of said waveguide at locations corresponding substantially to local maxima of a first two-dimensional generating function A¹(x,y) and the micro-reflective elements associated with the second structure are located on the planar surface (x,y) at locations corresponding substantially to local maxima of a second two-dimensional generating function A₂(x,y).

19. The optical device of claim 18, wherein one of said generating functions defines a plurality of elliptical lines and the other generating function defines a plurality of hyperbolic grating lines.

20. The optical device of claim 18, wherein the first and the second generating functions define a plurality of elliptical grating lines.

21. The optical device of claim 17, wherein said first structure reflects light as a divergent beam to said second structure.

22. The optical device of claim 17, wherein said first structure reflects light as a convergent beam to said second structure.

23. The optical device of claim 17, wherein said first structure reflects light as a substantially parallel beam to said second structure.

24. The optical device of claim 17, wherein said first and second structures provide flat top transfer functions.

25. The optical device of claim 18, wherein one of said generating functions includes a positive linear chirp and the other generating function includes a substantially compensating negative linear chirp.

26. The optical device of claim 17, further comprising a third photonic multi-bandgap structure in said waveguide forming a cascaded pair with said first structure such that for each pair of adjacent passband regions the first and second structures cooperatively direct light having wavelength components in one said passband regions from the input port to one pre-selected output port and the first and third structures cooperatively direct light having wavelength components in the other one of said passband regions from the input port to another pre-selected output port.

27. An optical device, comprising
an optical waveguide having at least one input port and a plurality of output ports, the waveguide being adapted for transmission of light having frequency components within a selected frequency range between said input and output ports,
a photonic multi-bandgap structure formed in said waveguide to direct light in each of a plurality of passband regions in said frequency range from the input port to one or more pre-selected output ports thereby providing a plurality of optical channels,
wherein each of said passband regions has a pre-selected bandwidth independent of bandwidths of other passband regions.

28. The optical device of claim 27, wherein at least two of said passband regions have different bandwidths.

29. The optical device of claim 27, wherein the photonic multi-bandgap structure is formed of a plurality of micro-reflective elements disposed on a surface (x,y) of said waveguide at locations corresponding substantially to local maxima of a two-dimensional generating function A(x,y) representing a two-dimensional profile of refraction index.

30. The optical device of claim 27, wherein the generating function A(x,y) defines a superposition of a plurality of sub-gratings, each sub-grating (i) being associated with a passband frequency ƒₗ and having a weight coefficient (αᵢ) related to a bandwidth Δƒₗ of the respective passband in accord with the relation:
Δƒₗ=καₗ
wherein κ is a proportionality constant.

31. The optical device of claim 30, wherein for each sub-grating (i) an optical path length is defined in accord with the relation:
$${l}_{i} ( 1 + {h}_{i} \frac{{l}_{i}}{{λ}_{i}} ) ,$$
wherein lᵢ is physical path length of light having a wavelength λₗ through the optical device, and hᵢ is a chirp coefficient for the sub-grating (i).

32. The optical device of claim 31, wherein at least two separate sub-gratings have different chirp coefficients.

33. An optical device, comprising
a planar optical waveguide formed of at least one core layer and a cladding layer and having at least one input port and a plurality of output ports, said waveguide being adapted for transmission of light having a plurality of passband regions within a selected wavelength range and having a TE or TM mode between said input and said output ports,
a photonic multi-bandgap structure optically formed in said waveguide, for each passband region, the photonic structure directing light having wavelength components within said passband region from said input port to at least a pre-selected output port,
wherein said core has a thickness and/or rerfraction index such that a birefringence of TE and TM modes induced by the waveguide planar geometry substantially compensates a birefringence induced by mechanical stress.

34. The optical device of claim 33, wherein the core is formed of silica and has a thickness in a range of about 3 to about 6 microns.

35. The optical device of claim 33, wherein a refraction index of said core differs from a refraction index of said cladding by more than about 0.005.

36. The optical device of claim 33, wherein said core layer is formed of silicon and said cladding layer is formed of silica.

37. A method of reducing birefringence related to a difference in effective refraction indices of a TE and TM mode in a planar waveguide comprising at least one core layer overlying a cladding layer, the method comprising the steps of:
selecting a thickness of the core such that a birefringence induced by mechanical stress substantially compensates birefringence induced by planar geometry of the waveguide.

38. A method of reducing birefringence related to a difference in effective refraction indices of a TE and TM mode in a planar waveguide comprising at least one core layer overlying a cladding layer, the method comprising the steps of:
selecting a difference in refraction indices of the core and cladding such that a birefringence induced by mechanical stress substantially compensates a birefringence induced by planar geometry of the waveguide.

39. An optical device, comprising
a planar waveguide having at least one input port and a plurality of output ports, said waveguide being adapted for transmission of light having TE or TM polarizations and having one or more passband regions within a selected frequency range (Δω) centered around frequency ω between said input and output ports, said waveguide exhibiting an effective refraction index associated with the TE mode γ_{E} and an effective refraction index associated with the TM mode γ_{M} related to one another in accord with the relation:
$$\frac{{γ}_{E} - {γ}_{M}}{{γ}_{E}} > \frac{Δ ω}{ω} ,$$
and
a photonic multi-bandgap structure optically formed in said waveguide,
wherein for each passband region within said selected frequency range, the photonic structure directs light having frequency components with said passband region from said input port to at least one pre-selected output port.

40. The optical device of claim 39, wherein γ_{E} and γ_{M} are related in accord with the relation:
$$\frac{{γ}_{E} - {γ}_{M}}{{γ}_{E}} > 2 \frac{Δ ω}{ω} .$$

41. The optical device of claim 39, wherein the planar waveguide comprises a core layer and a cladding layer such that an index of refraction of the core layer differs from an index of refraction of the cladding layer by more than about 10 percent.

42. An optical device, comprising
a planar waveguide comprising a semiconductor core layer and a cladding layer and an intermediate cladding layer positioned between said core layer and said cladding layer, said waveguide being adapted for transmission of light having a plurality of passband regions within a selected wavelength range,
an input port and a plurality of output ports formed in said waveguide, and
a photonic multi-bandgap structure formed at an interface of said intermediate cladding layer and said cladding layer, wherein for each passband region the photonic structure directs light having wavelength components within said passband region from said input port to at least one pre-selected output port.

43. The optical device of claim 42, wherein said cladding layer is a lower cladding layer on which the core layer is overlayed.

44. The optical device of claim 42, wherein said cladding layer is an upper cladding layer overlying the core layer.

45. An optical device, comprising
a planar waveguide having at least one input port and a plurality of output ports and being adapted for transmission of light having a plurality of passband regions within a selected wavelength range, and
a photonic multi-bandgap structure formed as plurality of micro-reflective elements disposed in a selected region of said waveguide such that a spacing between any two neighboring micro-reflective elements is substantially one-half of a wavelength of a wavelength component within one of said passband regions,
wherein for each passband region within said selected wavelength range, the photonic structure directs light having wavelength components within said passband region from said input port to at least one pre-selected output port.

46. The optical device of claim 45, wherein said waveguide comprises a plurality of layers and said micro-reflective elements are disposed at an interface of two of said layers.

47. An optical device, comprising
a planar waveguide having at least one input port and a plurality of output ports and being adapted for transmission of light having a plurality of passband regions within a selected wavelength range, and
a photonic multi-bandgap structure formed as a plurality of micro-reflective elements disposed in a selected region said waveguide, each micro-reflective element being formed by etching a portion of said waveguide surface to a depth substantially equal to one-half of a wavelength of a wavelength component within one of said passband regions,
wherein for each passband region within said selected wavelength range, the photonic structure directs light having wavelength components within said passband region from said input port to at least one pre-selected output port.

48. An optical device, comprising
a planar waveguide comprising at least one core layer having a top and bottom surface, said waveguide being adapted for transmission of light having a plurality of passband regions within a selected wavelength range from one input port to a plurality of output ports as a core mode or a radiating mode,
a photonic multi-bandgap structure formed as a plurality of micro-reflective elements in a selected region within said core layer located relative to the top and bottom surfaces such that scattering of light traveling through said waveguide and having a core mode into a radiating mode is less than about 1 percent,
wherein for each passband region within said wavelength range, the photonic structure directs light having wavelength components within said passband region from said input port to at least one pre-selected output port.

49. The optical device of claim 48, wherein said micro-reflective elements are formed on a planar region within said core layer located such that an intensity of a radiating mode relative to a core mode on said planar region is less than about 0.1.
